(19) United States
(12) Patent Application Publication
(10) Pub. No.: US 2023/0356859 A1
(43) Pub. Date: Nov. 9, 2023

(54) DIAGNOSTIC AND COMMUNICATION COMPONENT AND METHOD FOR AN ELECTRIC AIRCRAFT

(71) Applicant: BETA AIR, LLC, SOUTH BURLINGTON, VT (US)

(72) Inventors: Braedon Lohe, ESSEX JUNCTION, VT (US); Sean Donovan, RICHMOND, VT (US); Nathan William Joseph Wiegman, Williston, VT (US); Tom Michael Hughes, BRISTOL, VT (US)

(73) Assignee: BETA AIR, LLC, SOUTH BURLINGTON, VT (US)

(21) Appl. No.: 17/736,215

(22) Filed: May 4, 2022

(51) Int. Cl. B64F 5/40; B64F 5/60

(52) U.S. Cl. CPC B64F 5/40; B64F 5/60; B64D 2045/0085

(57) ABSTRACT

Provided in this disclosure are components and methods for diagnostic and communication for an electric aircraft. Components may include a diagnostic element connected to a flight component which may include a sensor and a diagnostic circuit. Component may detect a module datum, maintenance phenomenon, maintenance datum, and flight status. Flight status may be transmitted to a remote device accessible by a user.

### FIELD OF THE INVENTION

The present invention generally relates to the field of electric aircraft communication systems. In particular, the present invention is directed to diagnostic and communication component and method for an electric aircraft.

### BACKGROUND

The burgeoning of electric aircraft technologies promises an unprecedented forward leap in energy efficiency, cost savings, and the potential of future autonomous and unmanned aircraft. However, the technology of electric aircrafts is still lacking in crucial areas of wireless communications.

### SUMMARY OF THE DISCLOSURE

In an aspect of the present disclosure, a diagnostic and communication component for an electric aircraft, the component including: a diagnostic element installed in an electric aircraft and connected to at least a flight component, the diagnostic element including: at least a sensor configured to detect a maintenance phenomenon associated with the at least a flight component; and a diagnostic circuit configured to generate a maintenance datum as a function of the detected maintenance phenomenon; and a communication element communicatively connected to the diagnostic element, the communication element including a wireless transmitter, the wireless transmitter configured to transmit, to a local device exterior to the electric aircraft, the maintenance datum.

In another aspect of the present disclosure, a method for battery diagnostic and communication for an electric aircraft, the method including detecting, by sensor, a maintenance phenomenon associated with the at least a flight component; and generating, by diagnostic circuit, a maintenance datum as a function of the detected maintenance phenomenon; and transmitting, by wireless transmitter, to a local device exterior to the electric aircraft, the maintenance datum.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a block diagram of a battery diagnostic and communication component in an electrical aircraft;

FIG. 2 is an illustration of an exemplary embodiment of a sensor suite in partial cut-off view;

FIG. 3 is a block diagram of a system for a mesh network for an aircraft;

FIG. 4 is a flow chart of an exemplary embodiment of a method for battery diagnostic and communication in an electrical aircraft in one or more aspects of the present disclosure;

FIG. 5 is an illustration of an embodiment of an electric aircraft in one or more aspects of the present disclosure;

FIG. 6 is an illustration of an exemplary embodiment of a machine-learning model in in one or more aspect of the present disclosure;

FIG. 7 is a block diagram of a flight controller according to an embodiment of the disclosure; and

FIG. 8 is a block diagram of a computing system that can be used to implement any one or more of the methodologies disclosed herein and any one or more portions thereof in one or more aspects of the present disclosure.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to systems and methods for wireless maintenance communication. In an embodiment, a system for battery management may include one or more sensors configured to detect maintenance phenomenon and transmit maintenance datums to a flight controller. A remote device may be able to access the flight status that may be wirelessly transmitted from the flight controller. A user using the remote device may be able to determine whether the aircraft is flight ready using the system.

In the following description, for the purposes of explanation, numerous specific details are set forth in order to provide a thorough understanding of the present invention. It will be apparent, however, that the present invention may be practiced without these specific details. As used herein, the word “exemplary” or “illustrative” means “serving as an example, instance, or illustration.” Any implementation described herein as “exemplary” or “illustrative” is not necessarily to be construed as preferred or advantageous over other implementations. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply embodiments of the inventive concepts defined in the appended claims. Hence, specific dimensions and other physical characteristics relating to the embodiments disclosed herein are not to be considered as limiting, unless the claims expressly state otherwise.

In the following description, for the purposes of explanation, numerous specific details are set forth in order to provide a thorough understanding of the present invention. It will be apparent, however, that the present invention may be practiced without these specific details. As used herein, the word “exemplary” or “illustrative” means “serving as an example, instance, or illustration.” Any implementation described herein as “exemplary” or “illustrative” is not necessarily to be construed as preferred or advantageous over other implementations. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply embodiments of the inventive concepts defined in the appended claims. Hence, specific dimensions and other physical characteristics relating to the embodiments disclosed herein are not to be considered as limiting, unless the claims expressly state otherwise.

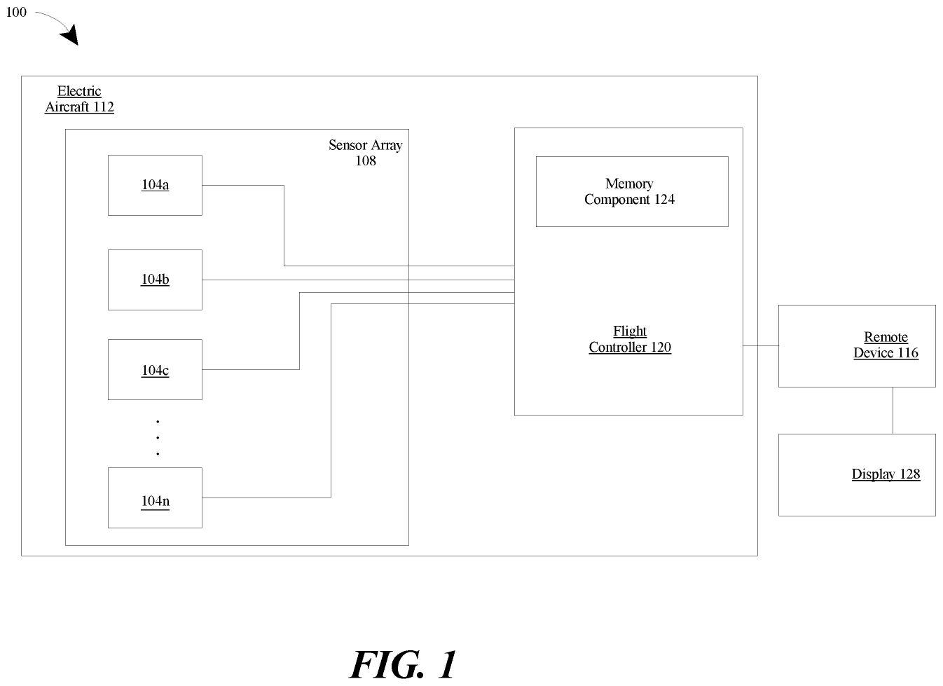

Referring now to FIG. 1, a component 100 for diagnostics and communication for an electric aircraft is shown in accordance with one or more embodiments of the present disclosure. Component 100 includes a diagnostic element. Diagnostic element may be connected to a flight component. Flight component may include a battery pack such that diagnostic element may be connected to a battery pack including at least a module. A battery module (also referred to as “module”) may be configured to provide energy to an electric aircraft via a power supply connection. For the purposes of this disclosure, a “power supply connection” is an electrical and/or physical communication between a battery module and electric aircraft that powers electric aircraft and/or electric aircraft subsystems for operation. In one or more embodiments, battery pack may include a plurality of battery modules. A “diagnostic element” as used herein is an element within the electric aircraft that includes components such as sensors that detect phenomenon associated with a flight component and the aircraft. A “flight component” as used herein is an element in the aircraft that is necessary for flight. At least a module monitoring unit is configured to sense a module datum of at least a module. In one or more embodiments, pack monitoring unit, discussed in further detail below, may include a sensor which may include a plurality of sensors 104a-n. In one or more embodiments, each sensor 104a-n is configured to detect a maintenance phenomenon, such as a characteristic or event. More, specifically each sensor 104a-n may detect the same maintenance phenomenon. For the purposes of this disclosure, a “maintenance phenomenon” is a sensor measurement related to a parameter of a maintenance characteristic and/or event. A “maintenance characteristic”, as used herein, is a characteristic relating to the health and status of an aircraft. Maintenance phenomenon may include a battery and a physical phenomenon. For instance, sensor 104a-n may detect a physical state or an electrical characteristic of an electric aircraft and/or a component thereof, such as a power source. In an exemplary embodiment, a state of a battery pack of an electric aircraft may be detected by sensor array 108. A state of a battery pack may include detectable information related to, for example, a state of charge (SOC), depth of discharge (DOD), temperature, a moisture level, a humidity, a voltage, a current, vent gas, vibrations, chemical content, or other measurable phenomenon of the battery pack and/or components thereof, such as a battery module and/or a battery cell.

As used in this disclosure, a “sensor” is a device that is configured to detect a phenomenon and transmit information and/or datum related to the detection of the phenomenon. For instance, and without limitation, a sensor may transform an electrical and/or nonelectrical stimulation into an electrical signal that is suitable to be processed by an electrical circuit, such as a controller. A sensor may generate a sensor output signal, which transmits information and/or datum related to a detection by the sensor. A sensor output signal may include any signal form described in this disclosure, such as for example, digital, analog, optical, electrical, fluidic, and the like. In some cases, a sensor, a circuit, and/or a controller may perform one or more signal processing steps on a signal. For instance, a sensor, circuit, and/or controller may analyze, modify, and/or synthesize a signal in order to improve the signal, for instance by improving transmission, storage efficiency, or signal to noise ratio.

In one or more embodiments, component 100 may include a plurality of sensor arrays 108, where each sensor array 108 includes a plurality of sensors 104a-n configured to detect a specific maintenance characteristic. For example, and without limitation, each sensor of a first sensor array 108 may be configured to detect a first maintenance phenomenon, such as a humidity level of a battery pack of an electric aircraft, while each sensor of a second sensor array 108 may be configured to detect a second maintenance phenomenon, such as the lock out tag out information of a part on the electric aircraft. One of ordinary skill in the art would understand that the terms “first” and “second” do not refer to either sensor array 108 as primary or secondary. In non-limiting embodiments, the first and second arrays, due to their physical isolation, may be configured to withstand malfunctions or failures in the other system and survive and operate. In one or more embodiments, the plurality of sensors 104a-n may be located within a close proximity to each other. In other embodiments, each sensor 104a-n may be remote to the other sensors of sensor array 108. For example, each sensor 104a-n may be positioned in a different location from the other sensors of sensor array 108. Positioning sensors 104a-n remotely from each other holds a benefit of avoiding the same environmental error affecting all the sensors of the sensory array 108. For example, and without limitation, if one sensor is short circuiting due to contacting a hot wire, the other sensors will not be affected by the malfunctioning sensor and may be able to better detect the malfunctioning sensor when determining the confidence level of the malfunctioning sensor.

In one or more embodiments, sensors 104a-n of sensor array 108 may be physically isolated from each other. “Physical isolation”, for the purposes of this disclosure, refers to a first system's components, communicative connection, and/or any other constituent parts, whether software or hardware, are separated from a second system's components, communicative connection, and any other constituent parts, whether software or hardware, respectively. In one or more embodiments, each sensor 104a-n may perform the same function and measure the same physical phenomenon as the other sensors of sensor array 108. Each sensor 104a-n of sensor array 108 may be the same type of sensor as the other sensors of sensor array 108 or each sensor 104a-n may be a different type of sensor that measures the same physical phenomenon as the other sensors of sensor array 108. For example, and without limitation, each sensor of a sensor array 108 may include a thermometer. In another embodiment, sensors of a sensor array 108 may include a thermometer, thermistor, infrared sensor, and the like.

Still referring to FIG. 1, sensors 104a-n may be electrically isolated from each other. “Electrical isolation”, for the purposes of this disclosure, refers to a first system's separation of components carrying electrical signals or electrical energy from a second system's components. Thus, if one sensor of sensor array 108 malfunctions or suffers an electrical catastrophe, rendering it inoperable or inaccurate, due to electrical isolation, the other sensors may still continue to operate and function normally, allowing for continued detection of physical phenomenon of the electric aircraft and/or components thereof. Shielding structural components, material selection, a combination thereof, or another undisclosed method of electrical isolation and insulation may be used in non-limiting embodiments. For example, and without limitation, a rubber or other electrically insulating material component may be disposed between electrical components of each sensor 104a-n, preventing electrical energy to be conducted through it, isolating each sensor 104a-n from each other.

Still referring to FIG. 1, each sensor 104a-n of sensor array 108 may be configured to transmit a maintenance datum related to the detected maintenance phenomenon. Maintenance datum is generated by a diagnostic circuit as a function of the detected maintenance phenomenon. Sensor array 108 may be included in the diagnostic circuit. A “diagnostic circuit” is a device unit that generates a maintenance datum in response to detected maintenance phenomenon from the sensors. In one or more embodiments, each sensor 104a-n may generate a sensor output signal that includes information and/or datum related to the detected event and/or phenomenon, such as, for example, maintenance datum 116a-n of sensors 104a-n respectively. For the purposes of this disclosure, “maintenance datum” is an electronic signal representing information and/or datum of a detected maintenance phenomenon associated with an electric aircraft. For example, and without limitation, maintenance datum may include a battery datum. Battery datum may include data of a condition parameter regarding a detected temperature of a battery cell. Battery datum may include data of the state of health of a battery. In another example, and without limitation, maintenance datum may include data of the lock out tag out information of a portion of the electric aircraft. Lock out tag out information may be determined by aircraft controller, discussed in further detail below. Lock out tag out information data may be user defined, such that a user may lock out an aircraft for safety concerns. In one or more embodiments, maintenance datum may include a state of charge (SOC) of a battery pack of electric aircraft 112, a depth of discharge (DOD) of a battery pack of electric aircraft 112, a temperature reading of one or more components of electric aircraft 112, a moisture/humidity level of a component of electric aircraft and/or of an environment surrounding electric aircraft 112, a gas level of a battery pack of electric aircraft 112, a chemical level of a battery pack of electric aircraft 112, a voltage of a component of the electric aircraft 112, a current of a component of electric aircraft 112, a pressure of a component of electric aircraft 112 and/or of an environment of electric aircraft 112, and the like.

Still referring to FIG. 1, flight controller 120 may identify an operating condition of an operating component or operating state of power source as a function of the maintenance datum. For purposes of this disclosure, an “operating condition” is an element of information regarding a current and/or present-time quality or working order of an operating state of a power source and/or a component thereof. Operating condition may be determined based on maintenance datum provided by sensor. For example, and without limitation, an operating condition for a SOC of power source may be 75%. In another example, and without limitation, an operating condition for a DOD (also referred to herein as a “State of Health (SOH)”) of power source 104 may be 20%, where DOD refers to a lifetime of power source=after repeated use. In yet another example, and without limitation, an operating condition for a state of temperature of power source may be 60° F. due to cool ambient temperatures caused by, for example, environmental weather. For the purposes of this disclosure, “state of charge” is the level of charge of an electric battery relative to its capacity. The units of SOC may be percentage points (0%=empty; 100%=full). An alternative form of the same measure is the depth of discharge (DOD), the inverse of SOC (100%=empty; 0%=full). SOC is normally used when discussing the current state of a battery in use, while DOD may be often seen when discussing the lifetime of the battery after repeated use. For the purposes of this disclosure, “state of health” is a figure of merit of the condition of a battery (or a cell, or a battery pack), compared to its ideal conditions. The units of SOH are percent points (100%=the battery's conditions match the battery's specifications). Typically, a battery's SOH will be 100% at the time of manufacture and will decrease over time and use. However, a battery's performance at the time of manufacture may not meet its specifications, in which case its initial SOH will be less than 100%.

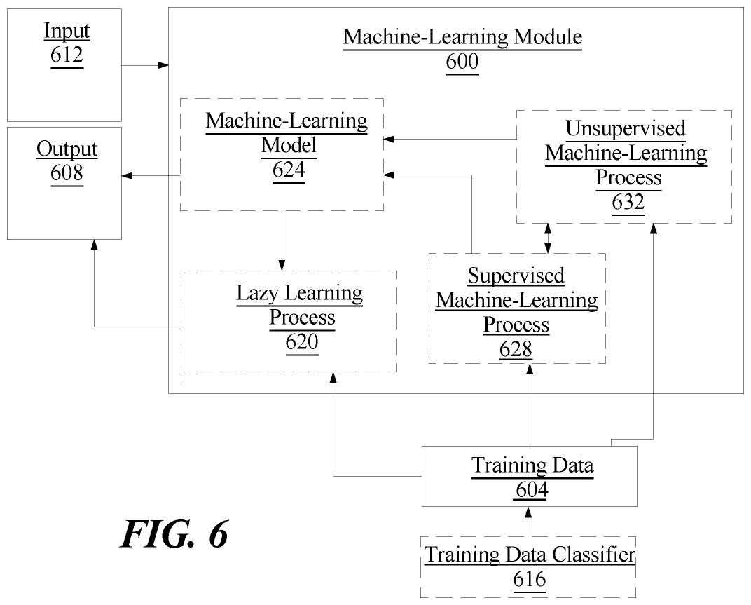

Still referring to FIG. 1, component 100 may include a flight controller 120 (also referred to as “controller” that is communicatively connected to each sensor 104a-n and/or sensor array 108. As used herein, “communicatively connected” is a process whereby one device, component, or circuit is able to receive data from and/or transmit data to another device, component, or circuit. In an embodiment, communicative connecting includes electrically connecting at least an output of one device, component, or circuit to at least an input of another device, component, or circuit. For example, and without limitation, each sensor 104a-n may be communicatively connected to controller 120. In one or more embodiments, a communicative connection between controller 120 and sensor array 108 may be wireless and/or wired. For example, and without limitation, controller 120 and sensor array 108 may communicative via a controller area network (CAN) communication. In one or more embodiments, controller 120 may include a computing device (as discussed in FIG. 6), a central processing unit (CPU), a microprocessor, a digital signal processor (DSP), an application specific integrated circuit (ASIC), a control circuit, a combination thereof, or the like. In one or more embodiments, output signals from sensors 104a-n and/or controller 120 of component 100 may be analog or digital. Controller 120 may convert output signals from each sensor 104a-n to a usable form by the destination of those signals. The usable form of output signals from sensors 104a-n and through controller 120 may be either digital, analog, a combination thereof, or an otherwise unstated form. Processing by controller 120 may be configured to trim, offset, or otherwise compensate the outputs of sensors. Based on output of the sensors, controller 120 may determine the output to send to a downstream component. Controller 120 may include signal amplification, operational amplifier (Op-Amp), filter, digital/analog conversion, linearization circuit, current-voltage change circuits, resistance change circuits such as Wheatstone Bridge, an error compensator circuit, a combination thereof or otherwise undisclosed components.

Continuing to reference FIG. 1, component 100 may include a flight controller 120 (also referred to herein as “controller”). Flight controller 120 may include any computing device as described in this disclosure, including without limitation a microcontroller, microprocessor, digital signal processor (DSP) and/or component on a chip (SoC) as described in this disclosure. Computing device may include, be included in, and/or communicate with a mobile device such as a mobile telephone or smartphone. Flight controller 120 may include a single computing device operating independently, or may include two or more computing device operating in concert, in parallel, sequentially or the like; two or more computing devices may be included together in a single computing device or in two or more computing devices. Flight controller 120 may interface or communicate with one or more additional devices as described below in further detail via a network interface device. Network interface device may be utilized for connecting Flight controller 120 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Flight controller 120 may include but is not limited to, for example, a computing device or cluster of computing devices in a first location and a second computing device or cluster of computing devices in a second location. Flight controller 120 may include one or more computing devices dedicated to data storage, security, distribution of traffic for load balancing, and the like. Flight controller 120 may distribute one or more computing tasks as described below across a plurality of computing devices of computing device, which may operate in parallel, in series, redundantly, or in any other manner used for distribution of tasks or memory between computing devices. Flight controller 120 may be implemented using a “shared nothing” architecture in which data is cached at the worker, in an embodiment, this may enable scalability of component 100 and/or computing device.

With continued reference to FIG. 1, flight controller 120 may be designed and/or configured to perform any method, method step, or sequence of method steps in any embodiment described in this disclosure, in any order and with any degree of repetition. For instance, flight controller 120 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Flight controller 120 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

In one or more embodiments, controller 120 may include a memory component 124. In one or more embodiments, memory component 124 may be configured to store datum related to sensor array 108, such as maintenance datum 116a-n from each of sensors 104a-n. For example, and without limitation, memory component 124 may store maintenance datum of each sensor 104a-n. In one or more embodiments, memory component 124 may include a database. In one or more embodiments, memory component 124 may include a solid-state memory or tape drive. In one or more embodiments, memory component 124 may be communicatively connected to sensors 104a-n and/or sensor array 108 and may be configured to receive electrical signals related to detected maintenance phenomenon and store such data for use and/or recall by controller 120 at a later time. Alternatively, memory component 124 may include a plurality of discrete memory components that are physically and/or electrically isolated from each other. One of ordinary skill in the art would understand the virtually limitless arrangements of data stores with which controller 120 could employ to store sensor data, such as measurement datum from each sensor 104a-n, and/or controller data.

In one or more embodiments, memory component 124 may be configured to save maintenance datum 116a-n, a predetermine threshold for one of more types of sensors, and the like periodically in regular intervals to memory component 124. “Regular intervals”, for the purposes of this disclosure, refers to an event taking place repeatedly after a certain amount of elapsed time. In one or more embodiments, controller 120 may include a timer that works in conjunction to determine regular intervals. In other embodiments, controller 120 may continuously store data from a sensor 104a-n in memory component 124. A timer may include a timing circuit, internal clock, or other circuit, component, or part configured to keep track of elapsed time and/or time of day. For example, in non-limiting embodiments, memory component 124 may save data from a sensor every 30 seconds, every minute, every 30 minutes, or another time period according to a timer. Additionally or alternatively, memory component 124 may save sensor data, such as maintenance data and/or a confidence level, after certain events occur, for example, in non-limiting embodiments, each power cycle, landing of the electric aircraft, when battery pack is charging or discharging, a failure of a battery cell, a malfunction of a sensor and/or sensor array 108, or scheduled maintenance periods. In non-limiting embodiments, maintenance datum of each sensor may be continuously transmitted to controller 120 and stored at an intermediary storage location, and then permanently saved by memory component 124 at a later time, like at a regular interval or after an event has taken place as mentioned previously.

In one or more embodiments, controller 120 may identify a state of sensor 104a-n as a function of a confidence level of sensor 104a-n. Confidence level may act as a threshold. As used in this disclosure, a “threshold” is a limit and/or range of an acceptable quantitative value or representation related to a normal phenomenon. In one or more embodiments, a state of a sensor is an operating condition of a sensor. For example, a sensor state may be “malfunctioning” or “operational”. For instance, and without limitation, if a confidence level of a sensor 104a-n exceeds a predetermined threshold, sensor 104a-n may be identified as a malfunctioning and/or malfunctioning sensor. In other embodiments, if a confidence level of a sensor 104a-n is within a predetermined threshold, sensor 104a-n may be identified as a properly operating and/or operational sensor. In one or more embodiments, if the confidence level of a sensor 104a-n is outside a predetermined threshold, then controller 120 may determine sensor 104a-n is malfunctioning and subsequently notify a user via, for example, display 128 on a remote device 116. For instance, and without limitation, an alert may be transmitted to a display 128 for viewing of maintenance datum and/or a confidence level by a user. For example, and without limitation, an alert may be shown on a graphical user interface (GUI), such as a control panel, of electric aircraft 112, or on a remote device 116, such as a mobile device, a laptop, a tablet, or the like. In one or more embodiments, the alert cannot be removed until the malfunctioning sensor is repaired or replaced with an operational sensor, where an operational sensor is one that has a confidence level within the predetermined threshold. In other embodiments, a user may deactivate the malfunctioning sensor in response to the determined confidence level and the identified exceeded threshold. In one or more embodiments, controller 120 may be continuously determining the confidence level of one or more sensors of sensor array 108. In other embodiments, controller 120 may determine the confidence level of one or more sensors of sensor array 108 at discrete time intervals.

In a non-limiting exemplary embodiment, if sensors 104a-n are like sensors then a mean of the sensors may be taken to determine the confidence level of a selected sensor. For example, and without limitation, if a selected sensor is first sensor 104a, controller 120 may determine the confidence level of sensor 104a by taking the average of the other sensors 104b-n and comparing measurement datum from first sensor 104a to the average of the measurement data from other sensors 104b-n. A predetermined threshold may include two standard deviations from identified average of the other sensors 104b-n. Thus, is the measurement datum of first sensor 104a is within two standard deviations of the average of the measurement datum of other sensors 104b-n, sensor 104a is within the threshold and has an acceptable confidence level. If the measurement datum of first sensors 104a is outside of two standard deviations of the average of the measurement datum of the other sensors 104b-n, then the confidence level of first sensor 104a is identified as unacceptable and a user will be alerted that first sensor 104a is malfunctioning.

Additional disclosure related to the confidence level of sensors can be found in U.S. patent application Ser. No. 17/688,415, filed on Mar. 7, 2022, entitled “SYSTEMS AND METHODS FOR DETERMINING A CONFIDENCE LEVEL OF A SENSOR MEASUREMENT BY A SENSOR OF AN ELECTRIC AIRCRAFT”, entirety of which incorporated herein by reference.

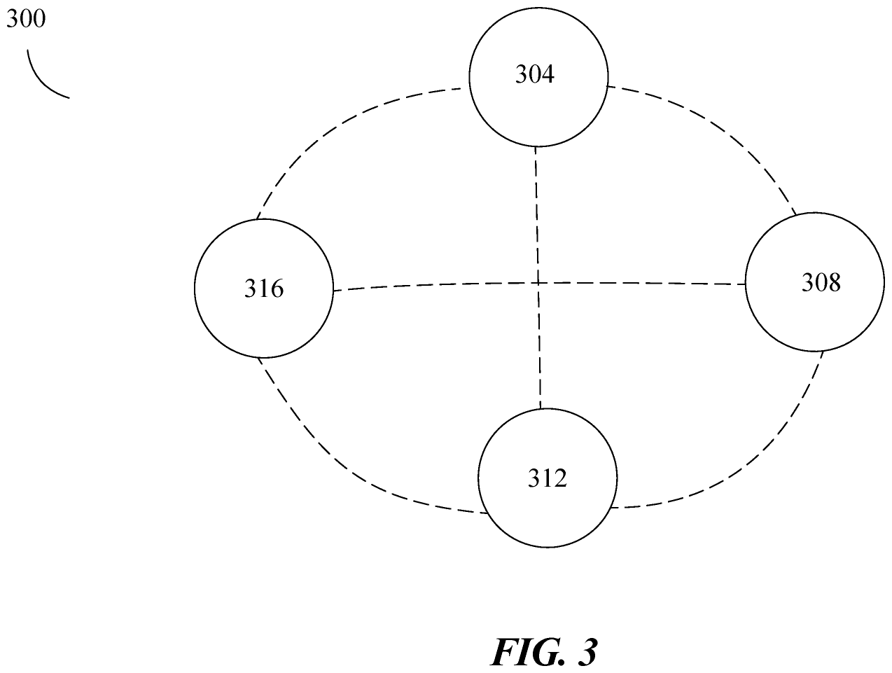

In one or more embodiments, controller 120 may be configured to receive the maintenance datum 116 from each sensor 104a-n of sensor array 108. For example, and without limitation, controller 120 may receive maintenance datum 116a-n, such as charge level of a battery in electric aircraft 112, from each sensor 104a-n of sensor array 108. In one or more embodiments, controller 120 receives maintenance datum 116a-n from each sensor 104a-n of sensor array 108 via network, such as a mesh network. Each sensor 104a-n and controller 120 on electric aircraft may be connected to generate a note of a multi node network, discussed in further detail in FIG. 3. In some embodiments, a node may be generated from a flight controller 120. In other embodiments, a node may be generated from a sensor 104a-n communicatively connected to a flight controller 120. Additionally or alternatively, and without limitation, controller 120 may receive measurement datum from a sensor via an isoSPI transceiver. In another example, controller 120 may receive measurement datum from a sensor via a controller area network (CAN) as discussed further in this disclosure.

With continued reference to FIG. 1, component 100 may include a physical controller area network (CAN) bus. A “controller area network bus” or “CAN bus” as used in this disclosure, is a physical vehicle bus unit including a central processing unit (CPU), a CAN controller, and a transceiver designed to allow devices to communicate with each other's applications without the need of a host computer which is located physically at electric aircraft. For instance and without limitation, CAN bus may be consistent with disclosure of CAN bus unit in U.S. patent application Ser. No. 17/218,342 and titled “METHOD AND SYSTEM FOR VIRTUALIZING A PLURALITY OF CONTROLLER AREA NETWORK BUS UNITS COMMUNICATIVELY CONNECTED TO AN AIRCRAFT,” which is incorporated herein by reference in its entirety. CAN bus may include physical circuit elements that may use, for instance and without limitation, twisted pair, digital circuit elements/FGPA, microcontroller, or the like to perform, without limitation, processing and/or signal transmission processes and/or tasks; circuit elements may be used to implement CAN bus components and/or constituent parts as described in further detail below. CAN bus may include multiplex electrical wiring for transmission of multiplexed signaling. CAN bus may include message-based protocol(s), wherein the invoking program sends a message to a process and relies on that process and its supporting infrastructure to then select and run appropriate programing. CAN bus may include a mechanical connection to electric aircraft, wherein the hardware of CAN bus is integrated within the infrastructure of electric aircraft.

With continued reference to FIG. 1, component 100 may use a pack monitoring unit (PMU) to receive and transmit a maintenance datum of an energy source on an electric aircraft. As used herein, “energy source” (also referred to as “power source”) is configured to power at least a portion of an electric vehicle and can include, without limitation, a cell. Energy source may include, without limitation, a generator, a photovoltaic device, a battery cell, a fuel cell such as a hydrogen fuel cell, direct methanol fuel cell, and/or solid oxide fuel cell, or an electric energy storage device; electric energy storage device may include without limitation a capacitor and/or a battery. A person of skill in the art will appreciate that energy source may be designed as to meet the energy or power requirement of various electric vehicles. A person of ordinary skill in the art will further appreciate that energy source can be designed to fit within a designated footprint on the various electric aircrafts. PMU may be configured to collect a condition parameter of the battery pack. For the purposes of this disclosure, a “condition parameter” is detected electrical or physical input and/or phenomenon related to a state of a battery pack. A condition parameter may be a maintenance phenomenon. A state of a battery pack may include detectable information related to, for example, a temperature, a moisture level, a humidity, a voltage, a current, vent gas, vibrations, chemical content, or other measurable characteristics of battery pack or components thereof, such as battery module 104 and/or battery cell 304. PMU may include a sensor 104a-n. Sensor 104a-n is configured to detect condition parameter of battery pack and generate a battery datum based on the condition parameter. As used in this disclosure, “battery datum” is an element of data encoding one or more condition parameters in an electrical signal such as a binary, analog, pulse width modulated, or other signal. For example, and without limitation, sensor 104a-n may transduce a detected phenomenon and/or characteristic of battery pack, such as, and without limitation, temperature, voltage, current, pressure, temperature, moisture level, and the like, into a sensed signal. A sensor 104a-n may include one or more sensors and may generate a sensor output signal, which transmits information and/or datum related to a sensor detection. A sensor output signal may include any signal form described in this disclosure, for example digital, analog, optical, electrical, fluidic, and the like. In some cases, a sensor, a circuit, and/or a controller may perform one or more signal processing steps on a signal. For instance, a sensor, circuit, and/or controller may analyze, modify, and/or synthesize a signal in order to improve the signal, for instance by improving transmission, storage efficiency, or signal to noise ratio. For example, and without limitation, sensor 104a-n may detect and/or measure a condition parameter, such as a temperature, of battery module. In one or more embodiments, a condition state of battery pack may include a condition state of a battery module and/or battery cell. Additional disclosure related to battery management can be found in U.S. patent application Ser. No. 17/528,896 filed on Nov. 17, 2021, entitled “SYSTEMS AND METHODS FOR BATTERY MANAGEMENT FOR ELECTRIC AIRCRAFT BATTERIES”, entirety of which in incorporated herein by reference. Sensor 104a-n may include one or more temperature sensors, voltmeters, current sensors, hydrometers, infrared sensors, photoelectric sensors, ionization smoke sensors, motion sensors, pressure sensors, radiation sensors, level sensors, imaging devices, moisture sensors, gas and chemical sensors, flame sensors, electrical sensors, imaging sensors, force sensors, Hall sensors, bolometers, and the like. Sensor 104a-n may be a contact or a non-contact sensor. For example, and without limitation, sensor may be connected to battery module and/or battery cell of battery pack. In other embodiments, sensor may be remote to battery module and/or battery cell. PMU may include a pressure sensor, a real time clock (RTC) sensor that is used to track the current time and date, a humidity sensor, an accelerometer/IMU, or other sensor.

Still referring to FIG. 1, in one or more embodiments, PMU may include and/or be communicatively connected to a module monitor unit (MMU), which may be mechanically connected and communicatively connected to battery module. In one or more embodiments, MMU may be communicatively connected to sensor 104 and configured to receive battery datum from sensor 104. MMU may then be configured to transmit battery datum and/or information based on battery datum to PMU. PMU may include and/or be communicatively connected to a controller, which is configured to receive battery datum and/or information based on battery datum from PMU. PMU may include a plurality of PMUs to create redundancy so that, if one PMU fails or malfunctions, another PMU may still operate properly. For example, PMU 116 may include PMUs. PMUs may be communicatively connected to the same of one or more of sensor 104. In some embodiments, PMU a may be connected to one or more of sensor 104 and PMU b may be connected to other one or more of sensor 104 to create redundancies in case of sensor failure.

In one or more embodiments, MMU may be configured to detect module datum of battery module. Module datum may include detectable information related to, for example, a temperature, a moisture level, a humidity, a voltage, a current, vent gas, vibrations, chemical content, or other measurable characteristics of battery pack, battery module, and/or a battery cell. For example, and without limitation, MMU may detect and/or measure a module datum, such as a temperature, of battery module. In one or more embodiments, a module datum of battery pack may include a maintenance phenomenon of battery module and/or a battery cell. In one or more embodiments, MMU may include sensor 104.

Still referring to FIG. 1, MMU may be configured to transmit a maintenance datum of battery module. MMU may generate an output signal such as maintenance datum that includes information regarding detected maintenance phenomenon. In one or more embodiments, maintenance datum be transmitted by MMU to PMU so that PMU may receive maintenance datum, and transmit maintenance datum to a wireless transmitter. For example, MMU may transmit battery data to flight controller of PMU.

In one or more embodiments, MMU may include a plurality of MMUs. For instance, and without limitation, each battery module may include one or more MMUs. For example, and without limitation, each battery module may include two MMUs. MMUs may be positioned on opposing sides of battery module. Battery module may include a plurality of MMUs to create redundancy so that, if one MMU fails or malfunctions, another MMU may still operate properly. In one or more nonlimiting exemplary embodiments, MMU may include mature technology so that there is a low risk. Furthermore, MMU may not include software, for example, to avoid complications often associated with programming. MMU may be configured to monitor and balance all battery cell groups of battery pack during charging of battery pack. For instance, and without limitation, MMU may monitor a temperature of battery module and/or a battery cell of battery module. For example, and without limitation, MMU may monitor a battery cell group temperature. In another example, and without limitation, MMU may monitor a terminal temperature to, for example, detect a poor HV electrical connection. In one or more embodiments, an MMU may be indirectly connected to PMU. In other embodiments, MMU may be directly connected to PMU. In one or more embodiments, MMU may be communicatively connected to an adjacent MMU.

Additional disclosure related to a module monitoring system can be found in U.S. patent application Ser. No. 17/529,447 entitled “A MODULE MONITOR UNIT FOR AN ELECTRIC AIRCRAFT BATTERY PACK AND METHODS OF USE”, entirety of which in incorporated herein by reference. Additional disclosure related to a pack monitoring system can be found in U.S. patent application Ser. No. 17/529,583 entitled “A PACK MONITORING UNIT FOR AN ELETRIC AIRCRAFT BATTERY PACK AND METHODS OF USE FOR BATTERY MANAGEMENT”, entirety of which in incorporated herein by reference.

Continuing to reference FIG. 1, component 100 may be further configured to include a communication element communicatively connected to the diagnostic element, the communication element including a wireless transmitter, the wireless transmitter configured to transmit, to a local device exterior to the electric aircraft, the maintenance datum. As used herein, a “communication element” is an element of the diagnostic element that is connected to a network via wireless transmitter. Wireless transmitter may transmit to a local device, a maintenance datum generated by a diagnostic circuit. A local device may be a flight controller 120 located external to the electric aircraft. Component 100 may be configured to identify the local device and authenticate the local device before transmitting a maintenance datum. In an embodiment, component 100 may request an identifier from a local device such as an IP address, password, secret, email address, etc. Identifier may be encrypted using a private key. Component 100 may decrypt an identifier using a public key of the private-public key pair. Component 100 may verify the local device by decrypting the identifier. In an embodiment, component 100 may verify local device to ensure that the maintenance datum is transmitted to the correct device. Local device may be configured to generate an aircraft status, as discussed below, and transmit the aircraft status to a remote device accessible by a user via network.

Continuing to refer to FIG. 1, local device such as flight controller 120 of component 100 may be configured to transmit an aircraft status related to the maintenance datum by way of network. Remote device 116 is configured to receive the aircraft status from the flight controller 120. Remote device 116 may be any computing device discussed in this disclosure. Network may be any network as discussed in this disclosure, such as a mesh network, Wi-Fi, LiFi, cellular, satellite, radio, and infrared communication bands and protocols. An “aircraft status”, as used herein, is data relating to the conditions of the aircraft. In an embodiment, aircraft status may include battery status as a function of a battery datum, lock out tag out status, as a function of the lock out tag out data, and the like. Aircraft status may include operating conditions as discussed above such as state of health and state of charge of a power source. Aircraft status may also include information on recalls of parts on the aircraft. Recalls of parts may be received by the flight controller 120 through wireless communications with other computing devices. In an embodiment, flight controller 120 may receive information on battery recalls from the battery manufacturer. Aircraft status may be transmitted to a remote device 116 and displayed on a display device. Aircraft status may be displayed as a combination of all the maintenance datums. Additionally or alternatively, aircraft status may also include any datums transmitted by the sensor 104a-n to the flight controller 120. In an embodiment, aircraft status may be displayed as a “Ready” or “Not Ready” or similar statement as a function of the maintenance datums. Aircraft status may be color coded to convey the condition of the aircraft. In an embodiment, aircraft status may be green, yellow, or red, to show the condition of the aircraft and whether the aircraft is in commission. Green may represent that the aircraft is ready for flight. Yellow may represent some outstanding issue that may be fixed easily. In an embodiment, those issues may include a low battery charge, or the like. Red may represent that the aircraft is grounded and not ready for flight. In an embodiment, aircraft may have a critical error that may be detected by the sensors in component 100. In an embodiment, sensor 104a-n may detect a poor state of health of the battery pack of the aircraft. In another embodiment, a user may lock out a component of the aircraft, such as a moving part of an aircraft, signaling that repairs may be needed. In another embodiment, an active recall status may indicate that the aircraft is not ready for flight. Remote device 116 may notify a user of a flight status through visual and auditory alerts. Examples of this are, but without limitation, a bell, a ringing noise, a flashing light, a change in color, or the like. Remote device 116 may notify user if a maintenance datum is not within the specified threshold of a sensor 104a-n, as discussed above. A visual and/or auditory alert may be presented in tandem with a critical information alert. A critical information alert may be presented without an accompanied auditory alert. As used herein, a “critical information alert” is a flight status that represents failures in an aircraft. In an embodiment, a critical information alert may require repairs to aircraft components, such as the propulsors, motors, frame, battery modules/packs, or the like. A critical information alert may show battery degradation such as a poor state of health and/or state of charge.

Continuing to reference FIG. 1, remote device 116 may receive and display the aircraft status. As used in this disclosure, a “remote device” is an external device to flight controller 120. Remote device 116 may include a display 128. For example, without limitation, flight status may be shown through a remote device 116 such as a VR goggle set, a tablet, a phone, a gaming device, a laptop, or the like. Other examples may include various types of displays including but not limited to electroluminescent display (ELD), a liquid crystal display (LCD), a light-emitting diode (LED), a plasma display (PDP), and/or a quantum dot display (QLED). Other displays may include a head mounted display, a head-up display, a display incorporated in eyeglasses, googles, headsets, helmet display systems, or the like, a display incorporated in contact lenses, an eye tap display system including without limitation a laser eye tap device, VRD, or the like. When developing remote device 116, it is important to keep in mind that remote device 116 may need to be easily visually accessible by user. Remote device 116 may be part of sensor 104a-n or a computing device or be a completely separate entity in aircraft. Remote device 116 may also be a stereoscopic display, which may denote a display that simulates a user experience of viewing a three-dimensional space and/or object, for instance by simulating and/or replicating different perspectives of a user's two eyes; this is in contrast to a two-dimensional image, in which images presented to each eye are substantially identical, such as may occur when viewing a flat screen display. Stereoscopic display may display two flat images having different perspectives, each to only one eye, which may simulate the appearance of an object or space as seen from the perspective of that eye. Alternatively or additionally, stereoscopic display may include a three-dimensional display such as a holographic display or the like. Persons skilled in the art, upon reviewing the entirety of this disclosure, will be aware of various optical projection and/or remote device 116 technologies that may be incorporated in component 100 consistently with this disclosure.

Still referring to FIG. 1, remote device 116 may be further configured to receive and transmit user interactions back to the flight controller 120. In this disclosure, a “user interaction” is when a user interacts with user interface, or in the case, remote device 116. A user may be any entity that interacts with aircraft 112. In an embodiment, a user may be part of the maintenance crew, a pilot, or the like. A user may interact with the display 128 through a graphical user interface. Examples of user interaction may be, but are not limited to, unlocking (in reference to lock out tag out) a component of the aircraft, silencing the alert, stopping flight of lights, manually changing thresholds of sensors, or the like. Additionally, a user may manually update a recall status, such as when a part has been replaced. Flight controller 120 may receive the user interaction and generate an updated flight status.

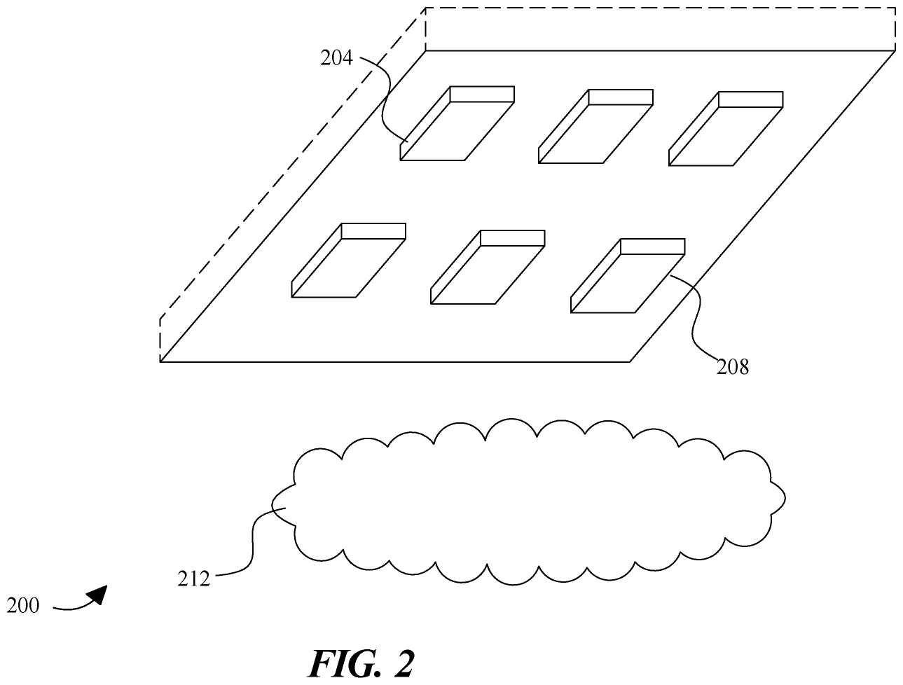

Referring now to FIG. 2, an embodiment of a sensor suite 200 is presented in accordance with one or more embodiments of the present disclosure. The herein disclosed components and methods may comprise a plurality of sensors in the form of individual sensors or a sensor suite working in tandem or individually. A sensor suite may include a sensor array having a plurality of independent sensors, as described in this disclosure, where any number of the described sensors may be used to detect any number of physical quantities associated with an electric aircraft. For example, sensor suite may include a plurality of sensor arrays where each sensor array includes a plurality of sensors detecting the same physical phenomenon. Independent sensors may include separate sensors measuring physical or electrical quantities that may be powered by and/or in communication with circuits independently, where each may signal sensor output to a control circuit such as a user graphical interface. In a non-limiting example, there may be four independent sensors housed in and/or on electric aircraft 112 and/or components thereof, such as battery pack of electric aircraft, measuring temperature, electrical characteristic such as voltage, amperage, resistance, or impedance, or any other parameters and/or quantities as described in this disclosure. In one or more embodiments, use of a plurality of independent sensors may also result in redundancy configured to employ more than one sensor that measures the same phenomenon, those sensors being of the same type, a combination of, or another type of sensor not disclosed, to detect a specific characteristic and/or phenomenon.

Sensor suite 200 may include a plurality of sensor arrays that each have a plurality of independent sensors 104a-n (shown in FIG. 1). In one or more embodiments, sensor suite 200 may include a sensor array of moisture sensors 204. “Moisture”, as used in this disclosure, is the presence of water, this may include vaporized water in air, condensation on the surfaces of objects, or concentrations of liquid water. Moisture may include humidity. “Humidity”, as used in this disclosure, is the property of a gaseous medium (almost always air) to hold water in the form of vapor. An amount of water vapor contained within a parcel of air can vary significantly. Water vapor is generally invisible to the human eye and may be damaging to electrical components. There are three primary measurements of humidity, absolute, relative, specific humidity. “Absolute humidity,” for the purposes of this disclosure, describes the water content of air and is expressed in either grams per cubic meters or grams per kilogram. “Relative humidity”, for the purposes of this disclosure, is expressed as a percentage, indicating a present stat of absolute humidity relative to a maximum humidity given the same temperature. “Specific humidity”, for the purposes of this disclosure, is the ratio of water vapor mass to total moist air parcel mass, where parcel is a given portion of a gaseous medium. An exemplary moisture sensor may include a psychrometer. Another exemplary moisture sensor may include a hygrometer. Another moisture sensor may include a humidistat. A “humidistat”, for the purposes of this disclosure, is a humidity-triggered switch, often used to control another electronic device. In one or more embodiments, a moisture sensor may use capacitance to measure relative humidity and include, in itself or as an external component, a device to convert relative humidity measurements to absolute humidity measurements. “Capacitance”, for the purposes of this disclosure, is the ability of a system to store an electric charge in, for example, a parcel of air.

With continued reference to FIG. 2, sensor suite 200 may include a sensor array of electrical sensors 208. An electrical sensor may be configured to measure a voltage across a component, electrical current through a component, and resistance of a component. In one or more non-limiting embodiments, an electrical sensor may include a voltmeter, ammeter, ohmmeter, and the like. Alternatively or additionally, sensor suite 200 may include a plurality of sensors that may detect voltage and direct the charging of individual battery cells of a battery pack of an electric aircraft according to charge level. Detection may be performed using any suitable component, set of components, and/or mechanism for direct or indirect measurement and/or detection of voltage levels, including without limitation comparators, analog to digital converters, any form of voltmeter, or the like. Sensor suite 200 and/or a control circuit incorporated therein and/or communicatively connected thereto may be configured to adjust charge to one or more battery cells as a function of a charge level and/or a detected parameter. For instance, and without limitation, sensor suite 200 may be configured to determine that a charge level of a battery cell is high based on a detected voltage level of that battery cell or portion of the battery pack. Sensor suite 200 may alternatively or additionally detect a charge reduction event, defined for purposes of this disclosure as any temporary or permanent state of a battery cell requiring reduction or cessation of charging; a charge reduction event may include a cell being fully charged and/or a cell undergoing a physical and/or electrical process that makes continued charging at a current voltage and/or current level inadvisable due to a risk that the cell will be damaged, will overheat, or the like. Detection of a charge reduction event may include detection of a temperature, of the cell above a threshold level, detection of a voltage and/or resistance level above or below a threshold, or the like.

With continued reference to FIG. 2, sensor suite 200 may include a sensor array of temperature sensors. In one or more embodiments, temperature sensors may include thermocouples, thermistors, thermometers, passive infrared sensors, resistance temperature sensors (RTDs), semiconductor based integrated circuits (IC), and the like. “Temperature”, for the purposes of this disclosure, and as would be appreciated by someone of ordinary skill in the art, is a measure of the heat energy of a system. Temperature, as measured by any number or combinations of sensors present within sensor suite 200, may be measured in Fahrenheit (° F.), Celsius (° C.), Kelvin (° K), or another scale alone, or in combination.

With continued reference to FIG. 2, sensor suite 200 may include a sensor array of gas sensors. In one or more embodiments, gas sensors may be configured to detect gas that may be emitted during or after a cell failure of a battery cell of an electric aircraft. “Cell failure”, for the purposes of this disclosure, refers to a malfunction of a battery cell, which may be an electrochemical cell, which renders the cell inoperable for its designed function, namely providing electrical energy to at least a portion of an electric aircraft. Byproducts 212 of cell failure may include gaseous discharge including oxygen, hydrogen, carbon dioxide, methane, carbon monoxide, a combination thereof, or another undisclosed gas, alone or in combination. A sensor configured to detect vent gas from electrochemical cells may comprise a gas detector. For the purposes of this disclosure, a “gas detector” is a device used to detect a gas is present in an area. Gas detectors, and more specifically, the gas sensor that may be used in sensor suite 200, may be configured to detect combustible, flammable, toxic, oxygen depleted, a combination thereof, or another type of gas alone or in combination. A gas sensor may include a combustible gas, photoionization detectors, electrochemical gas sensors, ultrasonic sensors, metal-oxide-semiconductor (MOS) sensors, infrared imaging sensors, a combination thereof, and the like. In one or more embodiments, sensor suite 200 may include sensor arrays of sensors that are configured to detect non-gaseous byproducts of cell failure including, in non-limiting examples, liquid chemical leaks, including aqueous alkaline solution, ionomer, molten phosphoric acid, liquid electrolytes with redox shuttle and ionomer, and salt water, among others. Sensor suite 200 may include sensors that are configured to detect non-gaseous byproducts of cell failure including, in non-limiting examples, electrical anomalies as detected by any of the previous disclosed sensors or components.

In one or more embodiments, sensor suite 200 may include a sensor array having an inertial measurement unit (IMU). In one or more embodiments, an IMU may be configured to detect a change in specific force of a body. An IMU may include an accelerometer, a gyro sensor, a gyroscope, a magnetometer, an E-compass, a G-sensor, a geomagnetic sensor, and the like. In one or more embodiments, IMU may include a global positioning system (GPS) or other positioning sensors. For example, and without limitation, an IMU may detect a geographical position and/or orientation of an electric aircraft relative to the surface of the earth.

Still referring to FIG. 2, a sensor suite 200 may include a sensor array having a plurality of motion sensors. A “motion sensor”, for the purposes of this disclosure, refers to a device or component configured to detect physical movement of an object or grouping of objects. One of ordinary skill in the art would appreciate, after reviewing the entirety of this disclosure, that motion may include a plurality of types including but not limited to: spinning, rotating, oscillating, gyrating, jumping, sliding, reciprocating, or the like. Sensor may include, torque sensor, gyroscope, accelerometer, magnetometer, inertial measurement unit (IMU), pressure sensor, force sensor, proximity sensor, displacement sensor, vibration sensor, or the like. For example, without limitation, a sensor may include a gyroscope that is configured to detect a current aircraft orientation, such as roll angle.

In one or more embodiments, sensor suite 200 may include a sensor array having a plurality of weather sensors. In one or more embodiments, sensor may include a wind sensor. In some embodiments, a wind sensor may be configured to measure a wind datum. A “wind datum” may include data of wind forces acting on an aircraft. Wind datum may include wind strength, direction, shifts, duration, or the like. For example, and without limitations, sensor may include an anemometer. An anemometer may be configured to detect a wind speed. In one or more embodiments, the anemometer may include a hot wire, laser doppler, ultrasonic, and/or pressure anemometer. In some embodiments, sensor may include a pressure sensor. “Pressure”, for the purposes of this disclosure and as would be appreciated by someone of ordinary skill in the art, is a measure of force required to stop a fluid from expanding and is usually stated in terms of force per unit area. The pressure sensor that may be included in sensor suite 200 may be configured to measure an atmospheric pressure and/or a change of atmospheric pressure. In some embodiments, the pressure sensor may include an absolute pressure sensor, a gauge pressure sensor, a vacuum pressure sensor, a differential pressure sensor, a sealed pressure sensor, and/or other unknown pressure sensors or alone or in a combination thereof. In one or more embodiments, a pressor sensor may include a barometer. In some embodiments, a pressure sensor may be used to indirectly measure fluid flow, speed, water level, and altitude. In some embodiments, the pressure sensor may be configured to transform a pressure into an analogue electrical signal. In some embodiments, the pressure sensor may be configured to transform a pressure into a digital signal.

In one or more embodiments, a sensor may include an altimeter that may be configured to detect an altitude of, for example, an electric aircraft. In some embodiments, the altimeter may include a pressure altimeter. In other embodiments, the altimeter may include a sonic, radar, and/or Global Positioning System (GPS) altimeter. In some embodiments, sensor may include a meteorological radar that monitors weather conditions. In some embodiments, sensor may include a ceilometer. The ceilometer may be configured to detect and measure a cloud ceiling and cloud base of an atmosphere. In some embodiments, the ceilometer may include an optical drum and/or laser ceilometer. In some embodiments, sensor may include a rain gauge. The rain gauge may be configured to measure precipitation. Precipitation may include rain, snow, hail, sleet, or other precipitation forms. In some embodiments, the rain gauge may include an optical, acoustic, or other rain gauge. In some embodiments, sensor may include a pyranometer. The pyranometer may be configured to measure solar radiation. In some embodiments, the pyranometer may include a thermopile and/or photovoltaic pyranometer. The pyranometer may be configured to measure solar irradiance on a planar surface. In some embodiments, sensor may include a lightning detector. The lightning detector may be configured to detect and measure lightning produced by thunderstorms. In some embodiments, sensor may include a present weather sensor (PWS). The PWS may be configured to detect the presence of hydrometeors and determine their type and intensity. Hydrometeors may include a weather phenomenon and/or entity involving water and/or water vapor, such as, but not limited to, rain, snow, drizzle, hail and sleet. In some embodiments, sensor 108 may include an inertia measurement unit (IMU). The IMU may be configured to detect a change in specific force of a body.

In one or more embodiments, sensor suite 200 may include a sensor array having a plurality of local sensors. A local sensor may be any sensor mounted to electric aircraft 112 that senses objects or events in the environment around electric aircraft 112. Local sensor may include, without limitation, a device that performs radio detection and ranging (RADAR), a device that performs lidar, a device that performs sound navigation ranging (SONAR), an optical device such as a camera, electro-optical (EO) sensors that produce images that mimic human sight, or the like. In one or more embodiments, sensor 208 may include a navigation sensor. For example, and without limitation, a navigation system of an electric aircraft may be provided that is configured to determine a geographical position of the electric aircraft, such as a geographical position of an electric aircraft during flight. The navigation may include a Global Positioning System (GPS), an Attitude Heading and Reference System (AHRS), an Inertial Reference System (IRS), radar system, and the like.

In one or more embodiments, sensor array may include various other types of sensors configured to detect a physical phenomenon related to electric aircraft 112. For instance, a sensor array may include a plurality of similar or different types of photoelectric sensors, similar or different types of pressure sensors, similar or different types of radiation sensors, similar or different types of force sensors, and the like. Sensors of a sensor array may include contact sensors, non-contact sensors, or a combination thereof. In one or more embodiments, sensor suite 200 may include digital sensors, analog sensors, or a combination thereof. Sensor suite 200 may include digital-to-analog converters (DAC), analog-to-digital converters (ADC, A/D, A-to-D), a combination thereof, or other signal conditioning components used in transmission of measurement data to a destination, such as controller 120, over a wireless and/or wired connection.

Now referring to FIG. 3, a block diagram of a system for a mesh network 300 for an electric aircraft. Node 304 may be designed and/or configured to perform any method, method step, or sequence of method steps in any embodiment described in this disclosure, in any order and with any degree of repetition. For instance, node 104 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Node 104 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

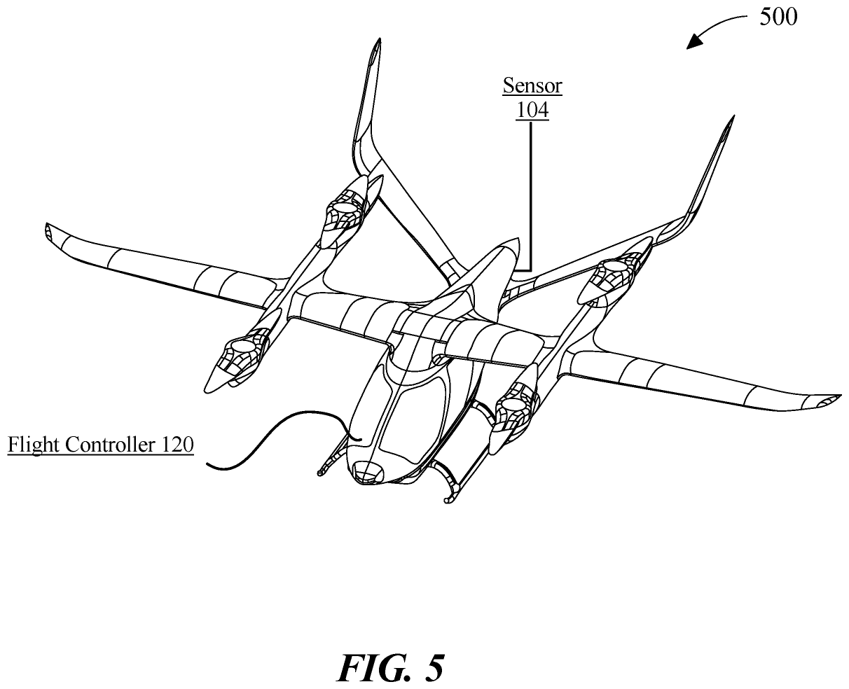

Still referring to FIG. 3, system 300 may include a plurality of nodes. In some embodiments, system 300 may include and/or communicate with a second node 308. In some embodiments, system 300 may include and/or communicate with a third node 312. In some embodiments, system 300 may include and/or communicate with a fourth node 316. A “node” as used in this disclosure is a computing device that is configured to receive and transmit data to another computing device. A node may include any computing device, such as, but not limited to, an electric aircraft, a laptop, a smartphone, a tablet, a command deck, a recharging pad, and/or other computing devices. In some embodiments, node 304 may include a computing device of a charger management system. In some embodiments, node 304, second node 308, third node 312, and fourth node 316 may include a computing device 112 of a charger management system. In some embodiments, node 304 may be configured to transmit and receive data from second node 308, third node 312, and/or fourth node 316. In some embodiments, second node 308 may be configured to transmit and receive data from node 304, third node 312, and/or fourth node 316. In some embodiments, third node 312 may be configured to transmit and receive data from node 304, second node 308, and/or fourth node 316. In some embodiments, fourth node 316 may be configured to transmit and receive data from first node 304, second node 308, and/or third node 312. System 300 may include and/or communicate with a plurality of nodes greater than four nodes. In some embodiments, system 300 may include less than four nodes. A node of system 300 may be configured to communicate data to another node of system 300. Data may include, but is not limited to, flight path data, battery charge data, locational data, speed data, acceleration data, propulsor data, power data, and/or other data. In some embodiments, data may include communication efficiency feedback. “Communication efficiency feedback,” as used in this disclosure, is any data concerning effectiveness of data transmission. In some embodiments, communication efficiency feedback may include, but is not limited to, signal strength, signal-noise ratio, error rate, availability of a higher-efficiency mode, physical trajectory of a second node, project change over time, relative strength of a third node, and the like. In some embodiments, system 300 may include and/or communicate with an initial recipient node. An “initial recipient node” as used in this disclosure is any node first transmitted to in a network. In some embodiments, first node 304 may include an initial recipient node. First node 304 may transmit data to second node 308. Second node 308 may transmit communication efficiency feedback to another node of system 300. In some embodiments, communication efficiency feedback may be based on data transmission times between two or more nodes. Communication efficiency feedback may be explicit. Explicit communication efficiency feedback may include second node 308 providing information to first node 304 about transmission times, error rates, signal-noise ratios, and the like. In some embodiments, second node 308 may provide communication efficiency feedback to first node 304 about one or more other nodes in system 300. Communication efficiency feedback about one or more other nodes of system 300 may include, but is not limited to, transmission speed, signal strength, error rate, signal-noise ratio, physical trajectory, availability, projected change over time, and the like. First node 304 may use communication efficiency feedback of second node 304 and/or one or more other nodes of system 300 to select an initial recipient node. Communication efficiency feedback may alternatively or additionally be implicit. Implicit communication efficiency feedback may include first node 304 detecting communication parameters such as, but not limited to, transmission speed, error rate, signal strength, physical trajectory, signal-noise ratio, and the like. First node 304 may determine one or more communication parameters based on a transmission between first node 304 and one or more other nodes of system 300. In some embodiments, first node 304 may store communication parameters of one or more other nodes. In a non-limiting example, first node 304 may store communication parameters of second node 304 which may include that second node 304 may have a high signal-noise ratio. First node 304 may search for another node of system 300 to select as an initial recipient node based on stored communication parameters of second node 308. In some embodiments, first node 304 may compare one or more communication parameters of a communication efficiency feedback of one or more nodes to select an initial recipient node. First node 304 may compare communication efficiency feedback to a communication threshold. A “communication threshold” as used in this disclosure is any minimum or maximum value of a communication metric. A communication threshold may include, but is not limited to, an error rate, a transmission speed, a signal-noise ratio, a physical trajectory, a signal strength, and the like. In some embodiments, first node 304 may receive data from second node 308 about a third node, fourth node, etc. Data about a third node, fourth node, etc. may include communication efficiency feedback. First node 304 may use data received from second node 308 about another node to select from a plurality of nodes of system 300. First node 304 may utilize a machine-learning model to predict an optimal communication pathway of nodes. A machine-learning model may be trained on training data correlating communication parameters to selected initial recipient nodes. Training data may be obtained from prior transmissions, stored data of one or more nodes, and/or received from an external computing device. In some embodiments, training data may be obtained from a user input. First node 304 may utilize a machine-learning model to compare one or more nodes based on one or more communication parameters for an optimal pathway selection. A machine-learning model may be as described below with reference to FIG. 5.

Still referring to FIG. 3, first node 304 may generate an objective function to compare communication parameters of two or more nodes. An “objective function” as used in this disclosure is a process of maximizing or minimizing one or more values based on a set of constraints. It some embodiments, an objective function of generated by first node 304 may include an optimization criterion. An optimization criterion may include any description of a desired value or of values for one or more attributes of a communication pathway; desired value or range of values may include a maximal or minimal value, a range between maximal or minimal values, or an instruction to maximize or minimize an attribute. As a non-limiting example, an optimization criterion of at least an optimization criterion may specify that a communication should have a fast transmission time; an optimization criterion may cap error rates of a transmission. An optimization criterion may specify one or more thresholds for communication parameters in transmission pathways. An optimization criterion may specify one or more desired physical trajectories for a communication pathway. In an embodiment, at least an optimization criterion may assign weights to different attributes or values associated with attributes; weights, as used herein, may be multipliers or other scalar numbers reflecting a relative importance of a particular attribute or value. As a non-limiting example, minimization of response time may be multiplied by a first weight, while a communication threshold above a certain value may be multiplied by a second weight. Optimization criteria may be combined in weighted or unweighted combinations into a function reflecting an overall outcome desired by a user; function may be a communication function to be minimized and/or maximized. Function may be defined by reference to communication constraints and/or weighted aggregation thereof; for instance, a communication function combining optimization criteria may seek to minimize or maximize a function of communication constraints.

Still referring to FIG. 3, first node 304 may use an objective function to compare second node 304 to one or more other nodes. Generation of an objective function may include generation of a function to score and weight factors to achieve a communication score for each feasible pairing. In some embodiments, pairings may be scored in a matrix for optimization, where columns represent nodes and rows represent communications potentially paired therewith; each cell of such a matrix may represent a score of a pairing of the corresponding node to the corresponding communication. In some embodiments, assigning a predicted process that optimizes the objective function includes performing a greedy algorithm process. A “greedy algorithm” is defined as an algorithm that selects locally optimal choices, which may or may not generate a globally optimal solution. For instance, first node 304 may select pairings so that scores associated therewith are the best score for each order and/or for each process. In such an example, optimization may determine the combination of processes such that each object pairing includes the highest score possible.

Still referring to FIG. 3, an objective function may be formulated as a linear objective function. First node 304 may solve objective function 344 using a linear program such as without limitation a mixed-integer program. A “linear program,” as used in this disclosure, is a program that optimizes a linear objective function, given at least a constraint. For instance, and without limitation, objective function may seek to maximize a total score Σ_{r∈R} Σ_{s∈S} cᵣₛxᵣₛ, where R is a set of all nodes r, S is a set of all communications s, cᵣₛ is a score of a pairing of a given node with a given communication, and xᵣₛ is 3 if a node r is paired with a communication s, and 0 otherwise. Continuing the example, constraints may specify that each node is assigned to only one communication, and each communication is assigned only one node. Communications may include communications and/or transmissions as described above. Sets of communications may be optimized for a maximum score combination of all generated communications. In various embodiments, first node 304 may determine a combination of nodes that maximizes a total score subject to a constraint that all nodes are paired to exactly one communication. In some embodiments, not all communications may receive a node pairing since each communication may only use one node. In some embodiments, an objective function may be formulated as a mixed integer optimization function. A “mixed integer optimization” as used in this disclosure is a program in which some or all of the variables are restricted to be integers. A mathematical solver may be implemented to solve for the set of feasible pairings that maximizes the sum of scores across all pairings; mathematical solver may be implemented on first node 304 and/or another device in system 300, and/or may be implemented on third-party solver.

With continued reference to FIG. 3, optimizing an objective function may include minimizing a loss function, where a “loss function” is an expression an output of which an optimization algorithm minimizes to generate an optimal result. As a non-limiting example, first node 304 may assign variables relating to a set of parameters, which may correspond to a score of communications as described above, calculate an output of mathematical expression using the variables, and select a pairing that produces an output having the lowest size, according to a given definition of “size,” of the set of outputs representing each of plurality of candidate ingredient combinations; size may, for instance, included absolute value, numerical size, or the like. Selection of different loss functions may result in identification of different potential pairings as generating minimal outputs. Objectives represented in an objective function and/or loss function may include minimization of response times. Objectives may include minimization of error rate of transmission. Objectives may include minimization of nodes used. Objectives may include minimization of signal-noise ratio. Objectives may include minimization of physical trajectory.

Still referring to FIG. 3, first node 304 may use a fuzzy inferential system to determine an initial recipient node. “Fuzzy inference” is the process of formulating a mapping from a given input to an output using fuzzy logic. “Fuzzy logic” is a form of many-valued logic in which the truth value of variables may be any real number between 0 and 1. Fuzzy logic may be employed to handle the concept of partial truth, where the truth value may range between completely true and completely false. The mapping of a given input to an output using fuzzy logic may provide a basis from which decisions may be made and/or patterns discerned. A first fuzzy set may be represented, without limitation, according to a first membership function representing a probability that an input falling on a first range of values is a member of the first fuzzy set, where the first membership function has values on a range of probabilities such as without limitation the interval [0,1], and an area beneath the first membership function may represent a set of values within the first fuzzy set. A first membership function may include any suitable function mapping a first range to a probability interval, including without limitation a triangular function defined by two linear elements such as line segments or planes that intersect at or below the top of the probability interval.

Still referring to FIG. 3, a first fuzzy set may represent any value or combination of values as described above, including communication parameters. A second fuzzy set, which may represent any value which may be represented by first fuzzy set, may be defined by a second membership function on a second range; second range may be identical and/or overlap with first range and/or may be combined with first range via Cartesian product or the like to generate a mapping permitting evaluation overlap of first fuzzy set and second fuzzy set. Where first fuzzy set and second fuzzy set have a region that overlaps, first membership function and second membership function may intersect at a point representing a probability, as defined on probability interval, of a match between first fuzzy set and second fuzzy set. Alternatively or additionally, a single value of first and/or second fuzzy set may be located at a locus on a first range and/or a second range, where a probability of membership may be taken by evaluation of a first membership function and/or a second membership function at that range point. A probability may be compared to a threshold to determine whether a positive match is indicated. A threshold may, in a non-limiting example, represent a degree of match between a first fuzzy set and a second fuzzy set, and/or single values therein with each other or with either set, which is sufficient for purposes of the matching process. In some embodiments, there may be multiple thresholds. Each threshold may be established by one or more user inputs. Alternatively or additionally, each threshold may be tuned by a machine-learning and/or statistical process, for instance and without limitation as described in further detail below.

Still referring to FIG. 3, first node 304 may use a fuzzy inference system to determine a plurality of outputs based on a plurality of inputs. A plurality of outputs may include a communication efficiency of one or more nodes. A plurality of inputs may include communication efficiency feedback as described above. In a non-limiting example, first node 304 may detect that second node 308 may have slow response time and a far physical trajectory. First node 304 may determine, using fuzzy logic, that second node 308 is “too far” for selection as an initial recipient node. In another non-limiting example, first node 304 may detect that second node 308 may have a high transmission speed and a close physical trajectory. First node 304 may determine that second node 308 has a “strong signal”.

Still referring to FIG. 3, first node 304 may determine a connectivity of a plurality of potential initial recipient nodes. First node 304 may determine, using any process described in this disclosure, an optimal initial recipient node according to a selection criteria. A selection criteria may include, but is not limited to, physical trajectory, projected change over time, signal strength, error rate, transmission speeds, response times, neighboring nodes, and the like. In some embodiments, each node of system 300 may iteratively ID initial recipient nodes and calculate a best option score and an average score. Each node may send a best option score and/or an average score to all nodes of system 300. A node of system 300 may calculi and update a best option score and/or an average score based on data received from other nodes of system 300. In some embodiments, by having each node update a best option score and average score of their own initial recipient nodes, first node 304 may select an initial recipient node based on robustness and speed of each possible pathway of other nodes of system 300.

In some embodiments, and continuing to refer to FIG. 3, node 304 may be generated from a flight controller 120 of an aircraft. In some embodiments, all nodes of system 300 may be generated from a flight controller 120 of an aircraft. In some embodiments, one node of system 300 may be generated from an aircraft and another node may be generated from a landing pad and/or recharging station. In some embodiments, a node 304 may be generated from an electric aircraft and may communicate charging data to node 308 which may be generated from a charging infrastructure. An electric aircraft may communicate with a charging infrastructure through one or more nodes of system 300. Communication between an electric aircraft and a charging infrastructure may include, but is not limited to, data communication about charge status of an electric aircraft, charging standards of an electric aircraft, charging compatibility of the charger 104 and the electric aircraft, estimated charging times, and the like.

Still referring to FIG. 3, in some embodiments, system 300 may include, participate in, and/or be incorporated in a network topology. A “network topology” as used in this disclosure is an arrangement of elements of a communication network. In some embodiments, system 300 may include, but is not limited to, a star network, tree network, and/or a mesh network. A “mesh network” as used in this disclosure is a local network topology in which the infrastructure nodes connect directly, dynamically, and non-hierarchically to as many other nodes as possible. Nodes of system 300 may be configured to communicate in a partial mesh network. A partial mesh network may include a communication system in which some nodes may be connected directly to one another while other nodes may need to connect to at least another node to reach a third node. In some embodiments, system 300 may be configured to communicate in a full mesh network. A full mesh network may include a communication system in which every node in the network may communicate directly to one another. In some embodiments, system 300 may include a layered data network. As used in this disclosure a “layered data network” is a data network with a plurality of substantially independent communication layers with each configured to allow for data transfer over predetermined bandwidths and frequencies. As used in this disclosure a “layer” is a distinct and independent functional and procedural tool of transferring data from one location to another. For example, and without limitation, one layer may transmit communication data at a particular frequency range while another layer may transmit communication data at another frequency range such that there is substantially no cross-talk between the two layers which advantageously provides a redundancy and safeguard in the event of a disruption in the operation of one of the layers. A layer may be an abstraction which is not tangible.

Still referring to FIG. 3, in some embodiments, system 300 may include node 304, second node 308, third node 332, and/or fourth node 336. Node 304 may be configured to communicate with a first layer providing radio communication between nodes at a first bandwidth. In some embodiments, node 304 may be configured to communicate with a second layer providing mobile network communication between the nodes at a second bandwidth. In some embodiments, node 304 may be configured to communicate with a third layer providing satellite communication between the nodes at a third bandwidth. In some embodiments, any node of system 300 may be configured to communicate with any layer of communication. In some embodiments, a node of system 300 may include an antenna configured to provide radio communication between one or more nodes. For example, and without limitation, an antenna may include a directional antenna. In an embodiment, system 300 may include a first bandwidth, a second bandwidth, and a third bandwidth. In some embodiments, system 300 may include more or less than three bandwidths. In some embodiments, a first bandwidth may be greater than a second bandwidth and a third bandwidth. In some embodiments, system 300 may be configured to provide mobile network communication in the form a cellular network, such as, but not limited to, 2G, 3G, 4G, 5G, LTE, and/or other cellular network standards.

Still referring to FIG. 3, radio communication, in accordance with embodiments, may utilize at least a communication band and communication protocols suitable for aircraft radio communication. For example, and without limitation, a very-high-frequency (VHF) air band with frequencies between about 108 MHz and about 137 MHz may be utilized for radio communication. In another example, and without limitation, frequencies in the Gigahertz range may be utilized. Airband or aircraft band is the name for a group of frequencies in the VHF radio spectrum allocated to radio communication in civil aviation, sometimes also referred to as VHF, or phonetically as “Victor”. Different sections of the band are used for radio-navigational aids and air traffic control. Radio communication protocols for aircraft are typically governed by the regulations of the Federal Aviation Authority (FAA) in the United States and by other regulatory authorities internationally. Radio communication protocols may employ, for example and without limitation an S band with frequencies in the range from about 2 GHz to about 4 GHz. For example, and without limitation, for 4G mobile network communication frequency bands in the range of about 2 GHz to about 8 GHz may be utilized, and for 5G mobile network communication frequency bands in the ranges of about 450 MHz to about 6 GHz and of about 24 GHz to about 53 GHz may be utilized. Mobile network communication may utilize, for example and without limitation, a mobile network protocol that allows users to move from one network to another with the same IP address. In some embodiments, a node of system 300 may be configured to transmit and/or receive a radio frequency transmission signal. A “radio frequency transmission signal,” as used in this disclosure, is an alternating electric current or voltage or of a magnetic, electric, or electromagnetic field or mechanical system in the frequency range from approximately 20 kHz to approximately 300 GHz. A radio frequency (RF) transmission signal may compose an analogue and/or digital signal received and be transmitted using functionality of output power of radio frequency from a transmitter to an antenna, and/or any RF receiver. A RF transmission signal may use longwave transmitter device for transmission of signals. An RF transmission signal may include a variety of frequency ranges, wavelength ranges, ITU designations, and IEEE bands including HF, VHF, UHF, L, S, C, X, Ku, K, Ka, V, W, mm, among others.

Still referring to FIG. 3, satellite communication, in accordance with embodiments, may utilize at least a communication band and communication protocols suitable for aircraft satellite communication. For example, and without limitation, satellite communication bands may include L-band (1-2 GHz), C-band (4-8 GHz), X-band (8-12 GHz), Ku-band (12-18 GHz), Ku-band (12-18 GHz), and the like, among others. Satellite communication protocols may employ, for example and without limitation, a Secondary Surveillance Radar (SSR) system, automated dependent surveillance-broadcast (ADS-B) system, or the like. In SSR, radar stations may use radar to interrogate transponders attached to or contained in aircraft and receive information in response describing such information as aircraft identity, codes describing flight plans, codes describing destination, and the like SSR may utilize any suitable interrogation mode, including Mode S interrogation for generalized information. ADS-B may implement two communication protocols, ADS-B-Out and ADS-B-In. ADS-B-Out may transmit aircraft position and ADS-B-In may receive aircraft position. Radio communication equipment may include any equipment suitable to carry on communication via electromagnetic waves at a particular bandwidth or bandwidth range, for example and without limitation, a receiver, a transmitter, a transceiver, an antenna, an aerial, and the like, among others. A mobile or cellular network communication equipment may include any equipment suitable to carry on communication via electromagnetic waves at a particular bandwidth or bandwidth range, for example and without limitation, a cellular phone, a smart phone, a personal digital assistant (PDA), a tablet, an antenna, an aerial, and the like, among others. A satellite communication equipment may include any equipment suitable to carry on communication via electromagnetic waves at a particular bandwidth or bandwidth range, for example and without limitation, a satellite data unit, an amplifier, an antenna, an aerial, and the like, among others.

Still referring to FIG. 3, as used in this disclosure “bandwidth” is measured as the amount of data that can be transferred from one point or location to another in a specific amount of time. The points or locations may be within a given network. Typically, bandwidth is expressed as a bitrate and measured in bits per second (bps). In some instances, bandwidth may also indicate a range within a band of wavelengths, frequencies, or energies, for example and without limitation, a range of radio frequencies which is utilized for a particular communication.

Still referring to FIG. 3, as used in this disclosure “antenna” is a rod, wire, aerial or other device used to transmit or receive signals such as, without limitation, radio signals and the like. A “directional antenna” or beam antenna is an antenna which radiates or receives greater power in specific directions allowing increased performance and reduced interference from unwanted sources. Typical examples of directional antennas include the Yagi antenna, the log-periodic antenna, and the corner reflector antenna. The directional antenna may include a high-gain antenna (HGA) which is a directional antenna with a focused, narrow radio wave beamwidth and a low-gain antenna (LGA) which is an omnidirectional antenna with a broad radio wave beamwidth, as needed or desired.

With continued reference to FIG. 3, as used in this disclosure, a “signal” is any intelligible representation of data, for example from one device to another. A signal may include an optical signal, a hydraulic signal, a pneumatic signal, a mechanical, signal, an electric signal, a digital signal, an analog signal and the like. In some cases, a signal may be used to communicate with a computing device, for example by way of one or more ports. In some cases, a signal may be transmitted and/or received by a computing device for example by way of an input/output port. An analog signal may be digitized, for example by way of an analog to digital converter. In some cases, an analog signal may be processed, for example by way of any analog signal processing steps described in this disclosure, prior to digitization. In some cases, a digital signal may be used to communicate between two or more devices, including without limitation computing devices. In some cases, a digital signal may be communicated by way of one or more communication protocols, including without limitation internet protocol (IP), controller area network (CAN) protocols, serial communication protocols (e.g., universal asynchronous receiver-transmitter [UART]), parallel communication protocols (e.g., IEEE 128 [printer port]), and the like.

Still referring to FIG. 3, in some cases, a node of system 300 may perform one or more signal processing steps on a sensed characteristic. For instance, a node may analyze, modify, and/or synthesize a signal representative of characteristic in order to improve the signal, for instance by improving transmission, storage efficiency, or signal to noise ratio. Exemplary methods of signal processing may include analog, continuous time, discrete, digital, nonlinear, and statistical. Analog signal processing may be performed on non-digitized or analog signals. Exemplary analog processes may include passive filters, active filters, additive mixers, integrators, delay lines, compandors, multipliers, voltage-controlled filters, voltage-controlled oscillators, and phase-locked loops. Continuous-time signal processing may be used, in some cases, to process signals which varying continuously within a domain, for instance time. Exemplary non-limiting continuous time processes may include time domain processing, frequency domain processing (Fourier transform), and complex frequency domain processing. Discrete time signal processing may be used when a signal is sampled non-continuously or at discrete time intervals (i.e., quantized in time). Analog discrete-time signal processing may process a signal using the following exemplary circuits sample and hold circuits, analog time-division multiplexers, analog delay lines and analog feedback shift registers. Digital signal processing may be used to process digitized discrete-time sampled signals. Commonly, digital signal processing may be performed by a computing device or other specialized digital circuits, such as without limitation an application specific integrated circuit (ASIC), a field-programmable gate array (FPGA), or a specialized digital signal processor (DSP). Digital signal processing may be used to perform any combination of typical arithmetical operations, including fixed-point and floating-point, real-valued and complex-valued, multiplication and addition. Digital signal processing may additionally operate circular buffers and lookup tables. Further non-limiting examples of algorithms that may be performed according to digital signal processing techniques include fast Fourier transform (FFT), finite impulse response (FIR) filter, infinite impulse response (IIR) filter, and adaptive filters such as the Wiener and Kalman filters. Statistical signal processing may be used to process a signal as a random function (i.e., a stochastic process), utilizing statistical properties. For instance, in some embodiments, a signal may be modeled with a probability distribution indicating noise, which then may be used to reduce noise in a processed signal. Additional disclosure related to mesh networks can be found in U.S. patent application Ser. No. 17/478,067 entitled “SYSTEM FOR MESH NETWORK FOR USE IN AIRCRAFTS”, entirety of which incorporated herein by reference.

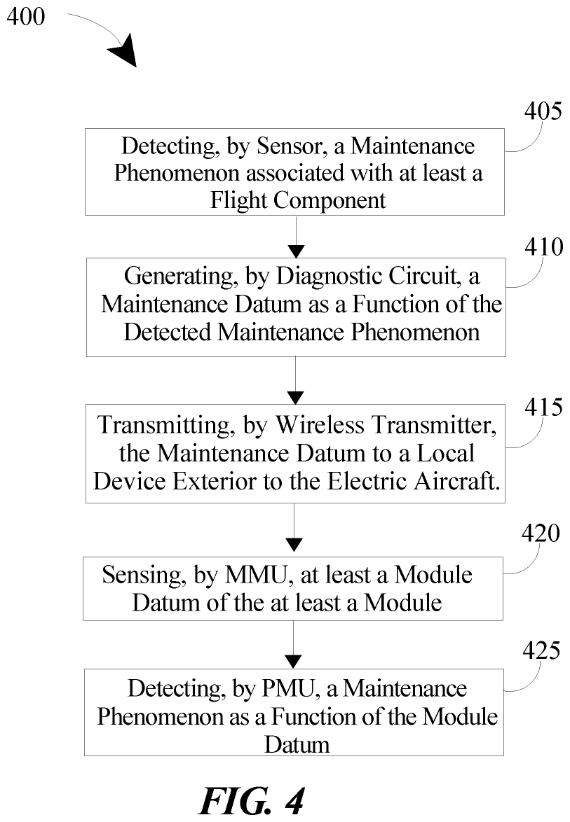

Now referring to FIG. 4, a method 400 for wireless maintenance communication for an electric aircraft. Step 405 of method 400 includes detecting, by sensor 104a-n a maintenance phenomenon associated with at least a flight component. A maintenance phenomenon may refer to any detected phenomenon that affects the operation conditions of the aircraft. Step 410 includes generating, by diagnostic circuit, a maintenance datum as a function of the detected maintenance phenomenon. Maintenance phenomenon and maintenance datum may be any phenomenon or datum as discussed in this disclosure.

Step 415 of method 400 includes transmitting, by wireless transmitter, an aircraft status related to the maintenance datum by way of network. Flight controller 120 may determine an aircraft status using the maintenance datum recorded by the sensor 104a-n and transmitted to the aircraft. Flight controller 120 may use a machine-learning module to determine an aircraft status. Machine-learning modules are discussed in further detail in FIG. 6. For example, and without limitation, a machine-learning module and/or process may use a training data set, which includes training data, to generate an algorithm and create a machine-learning model that can determine a confidence level for various types of sensors based on measurement datum. Training data may include inputs and corresponding predetermined outputs so that a machine-learning module may use the correlations between the provided exemplary inputs and outputs to develop an algorithm and/or relationship that then allows the machine-learning module to determine its own outputs for inputs. Training data may contain correlations that a machine-learning process may use to model relationships between two or more categories of data elements. The exemplary inputs and outputs may come from a database or be provided by a user. In other embodiments, a machine-learning module may obtain a training set by querying a communicatively connected database that includes past inputs and outputs. Training data may include inputs from various types of sensors and outputs correlated to each of those inputs so that a machine-learning module may determine an output for any type of sensor 104a-n used in sensor array 108. Correlations may indicate causative and/or predictive links between data, which may be modeled as relationships, such as mathematical relationships, by machine-learning processes, as described in further detail below. In one or more embodiments, training data may be formatted and/or organized by categories of data elements by, for example, associating data elements with one or more descriptors corresponding to categories of data elements. As a non-limiting example, training data may include data entered in standardized forms by persons or processes, such that entry of a given data element in a given field in a form may be mapped to one or more descriptors of categories. Elements in training data may be linked to descriptors of categories by tags, tokens, or other data elements. Additionally, training data may be updated by using user interaction. In an embodiment, there may be a feedback loop in which a user may update flight status manually. Machine-learning module may create a second set of training data using user interaction to iteratively improve the module.

Still referring to FIG. 4, in some exemplary embodiments, method 400 may include step 420 and/or 425. At step 420 method may include sensing, by MMU at least a module datum of the at least a module. Module datum may be consistent with any module datum as discussed in this disclosure. Step 425 of method 400 may include detecting, by PMU, a maintenance phenomenon as a function of the module datum. In an embodiment, PMU and MMU may be associated with a battery pack and may relay information about the operations of the battery pack to a wireless transmitter.

In one or more embodiments, training data may be filtered, sorted, and/or selected using one or more supervised and/or unsupervised machine-learning processes and/or models, as described in further detail below. Such models may include a training data classifier. A training data classifier may include a mathematical model, neural net, or program generated by a machine learning algorithm that sorts inputs into categories or bins of data and, subsequently, outputs the categories or bins of data and/or labels associated therewith. A classifier may be configured to output at least a datum that labels or otherwise identifies a set of data that are clustered together, found to be close under a distance metric as described below, or the like. For example, and without limitation, a measurement datum may be classified and sorted based on the type of sensor that detects the corresponding physical phenomenon and/or based on the unit and/or type of measurement datum generated. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers.

Step 425 of method 400 includes receiving, by remote device 116, the aircraft status. Remote device 116 may be any computing device as discussed in this disclosure. Remote device 116 may allow for user interaction. Step 430 of method 400 includes displaying, by remote device 116, the aircraft status. Display 128 may be physically and/or communicatively connected to the remote device 116. Display 128 may include a graphical user interface. Remote device 116 may be at any location at or away from the flight controller 120.

Now referring to FIG. 5, an exemplary embodiment of an electric aircraft 500. Electric aircraft 500 may include an electrical vertical takeoff and landing (eVTOL) aircraft. As used herein, a vertical take-off and landing (eVTOL) aircraft is one that can hover, take off, and land vertically. An eVTOL, as used herein, is an electrically powered aircraft typically using an energy source 104 of a plurality of energy sources to power the aircraft. In order to optimize the power and energy necessary to propel the aircraft. eVTOL may be capable of rotor-based cruising flight, rotor-based takeoff, rotor-based landing, fixed-wing cruising flight, airplane-style takeoff, airplane-style landing, and/or any combination thereof. Rotor-based flight, as described herein, is where the aircraft generated lift and propulsion by way of one or more powered rotors coupled with an engine, such as a “quad copter,” multi-rotor helicopter, or other vehicle that maintains its lift primarily using downward thrusting propulsors. Fixed-wing flight, as described herein, is where the aircraft is capable of flight using wings and/or foils that generate lift caused by the aircraft's forward airspeed and the shape of the wings and/or foils, such as airplane-style flight.

As used in this disclosure a “propulsor component” or “propulsor” is a component and/or device used to propel a craft by exerting force on a fluid medium, which may include a gaseous medium such as air or a liquid medium such as water. In an embodiment, when a propulsor twists and pulls air behind it, it may, at the same time, push an aircraft forward with an amount of force and/or thrust. More air pulled behind an aircraft results in greater thrust with which the aircraft is pushed forward. Propulsor component may include any device or component that consumes electrical power on demand to propel an electric aircraft in a direction or other vehicle while on ground or in-flight. In an embodiment, propulsor component may include a puller component. As used in this disclosure a “puller component” is a component that pulls and/or tows an aircraft through a medium. As a non-limiting example, puller component may include a flight component such as a puller propeller, a puller motor, a puller propulsor, and the like. Additionally, or alternatively, puller component may include a plurality of puller flight components. In another embodiment, propulsor component may include a pusher component. As used in this disclosure a “pusher component” is a component that pushes and/or thrusts an aircraft through a medium. As a non-limiting example, pusher component may include a pusher component such as a pusher propeller, a pusher motor, a pusher propulsor, and the like. Additionally, or alternatively, pusher flight component may include a plurality of pusher flight components.

Referring now to FIG. 6, an exemplary embodiment of a machine-learning module 600 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 604 to generate an algorithm that will be performed by a computing device/module to produce outputs 608 given data provided as inputs 612; this is in contrast to a non-machine learning software program where the commands to be executed are determined in advance by a user and written in a programming language.

Still referring to FIG. 6, “training data,” as used herein, is data containing correlations that a machine-learning process may use to model relationships between two or more categories of data elements. For instance, and without limitation, training data 604 may include a plurality of data entries, each entry representing a set of data elements that were recorded, received, and/or generated together; data elements may be correlated by shared existence in a given data entry, by proximity in a given data entry, or the like. Multiple data entries in training data 604 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 604 according to various correlations; correlations may indicate causative and/or predictive links between categories of data elements, which may be modeled as relationships such as mathematical relationships by machine-learning processes as described in further detail below. Training data 604 may be formatted and/or organized by categories of data elements, for instance by associating data elements with one or more descriptors corresponding to categories of data elements. As a non-limiting example, training data 604 may include data entered in standardized forms by persons or processes, such that entry of a given data element in a given field in a form may be mapped to one or more descriptors of categories. Elements in training data 604 may be linked to descriptors of categories by tags, tokens, or other data elements; for instance, and without limitation, training data 604 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 6, training data 604 may include one or more elements that are not categorized; that is, training data 604 may not be formatted or contain descriptors for some elements of data. Machine-learning algorithms and/or other processes may sort training data 604 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 604 to be made applicable for two or more distinct machine-learning algorithms as described in further detail below. Training data 604 used by machine-learning module 600 may correlate any input data as described in this disclosure to any output data as described in this disclosure. As a non-limiting illustrative example flight elements and/or pilot signals may be inputs, wherein an output may be an autonomous function.

Further referring to FIG. 6, training data may be filtered, sorted, and/or selected using one or more supervised and/or unsupervised machine-learning processes and/or models as described in further detail below; such models may include without limitation a training data classifier 616. Training data classifier 616 may include a “classifier,” which as used in this disclosure is a machine-learning model as defined below, such as a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. Machine-learning module 600 may generate a classifier using a classification algorithm, defined as a processes whereby a computing device and/or any module and/or component operating thereon derives a classifier from training data 604. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 416 may classify elements of training data to sub-categories of flight elements such as torques, forces, thrusts, directions, and the like thereof.

Still referring to FIG. 6, machine-learning module 600 may be configured to perform a lazy-learning process 620 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 604. Heuristic may include selecting some number of highest-ranking associations and/or training data 604 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 6, machine-learning processes as described in this disclosure may be used to generate machine-learning models 624. A “machine-learning model,” as used in this disclosure, is a mathematical and/or algorithmic representation of a relationship between inputs and outputs, as generated using any machine-learning process including without limitation any process as described above, and stored in memory; an input is submitted to a machine-learning model 624 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 624 may be generated by creating an artificial neural network, such as a convolutional neural network comprising an input layer of nodes, one or more intermediate layers, and an output layer of nodes. Connections between nodes may be created via the process of “training” the network, in which elements from a training data 604 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 6, machine-learning algorithms may include at least a supervised machine-learning process 628. At least a supervised machine-learning process 628, as defined herein, include algorithms that receive a training set relating a number of inputs to a number of outputs, and seek to find one or more mathematical relations relating inputs to outputs, where each of the one or more mathematical relations is optimal according to some criterion specified to the algorithm using some scoring function. For instance, a supervised learning algorithm may include flight elements and/or pilot signals as described above as inputs, autonomous functions as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 604. Persons skilled in the art, upon reviewing the entirety of this disclosure, will be aware of various possible variations of at least a supervised machine-learning process 628 that may be used to determine relation between inputs and outputs. Supervised machine-learning processes may include classification algorithms as defined above.

Further referring to FIG. 6, machine learning processes may include at least an unsupervised machine-learning processes 632. An unsupervised machine-learning process, as used herein, is a process that derives inferences in datasets without regard to labels; as a result, an unsupervised machine-learning process may be free to discover any structure, relationship, and/or correlation provided in the data. Unsupervised processes may not require a response variable; unsupervised processes may be used to find interesting patterns and/or inferences between variables, to determine a degree of correlation between two or more variables, or the like.

Still referring to FIG. 6, machine-learning module 600 may be designed and configured to create a machine-learning model 624 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 6, machine-learning algorithms may include, without limitation, linear discriminant analysis. Machine-learning algorithm may include quadratic discriminate analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized tress, AdaBoost, gradient tree boosting, and/or voting classifier methods. Machine-learning algorithms may include neural net algorithms, including convolutional neural net processes.

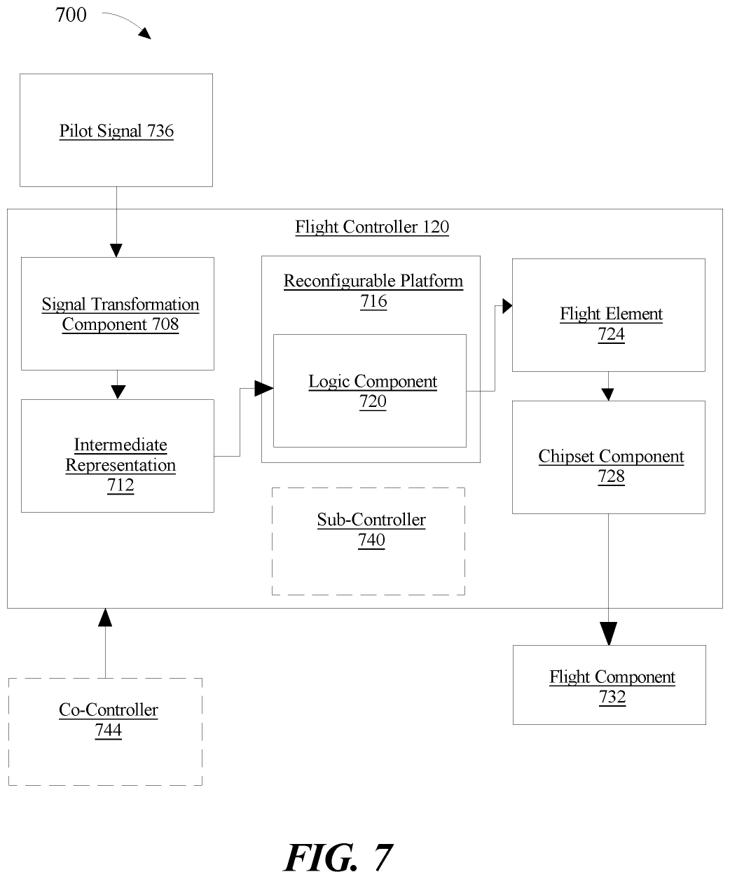

Now referring to FIG. 7, an exemplary embodiment 700 of a flight controller 704 is illustrated. As used in this disclosure a “flight controller” is a computing device of a plurality of computing devices dedicated to data storage, security, distribution of traffic for load balancing, and flight instruction. Flight controller 120 may include and/or communicate with any computing device as described in this disclosure, including without limitation a microcontroller, microprocessor, digital signal processor (DSP) and/or system on a chip (SoC) as described in this disclosure. Further, flight controller 120 may include a single computing device operating independently, or may include two or more computing device operating in concert, in parallel, sequentially or the like; two or more computing devices may be included together in a single computing device or in two or more computing devices. In embodiments, flight controller 120 may be installed in an aircraft, may control the aircraft remotely, and/or may include an element installed in the aircraft and a remote element in communication therewith.

In an embodiment, and still referring to FIG. 7, flight controller 120 may include a signal transformation component 708. As used in this disclosure a “signal transformation component” is a component that transforms and/or converts a first signal to a second signal, wherein a signal may include one or more digital and/or analog signals. For example, and without limitation, signal transformation component 708 may be configured to perform one or more operations such as preprocessing, lexical analysis, parsing, semantic analysis, and the like thereof. In an embodiment, and without limitation, signal transformation component 708 may include one or more analog-to-digital convertors that transform a first signal of an analog signal to a second signal of a digital signal. For example, and without limitation, an analog-to-digital converter may convert an analog input signal to a 10-bit binary digital representation of that signal. In another embodiment, signal transformation component 708 may include transforming one or more low-level languages such as, but not limited to, machine languages and/or assembly languages. For example, and without limitation, signal transformation component 708 may include transforming a binary language signal to an assembly language signal. In an embodiment, and without limitation, signal transformation component 708 may include transforming one or more high-level languages and/or formal languages such as but not limited to alphabets, strings, and/or languages. For example, and without limitation, high-level languages may include one or more system languages, scripting languages, domain-specific languages, visual languages, esoteric languages, and the like thereof. As a further non-limiting example, high-level languages may include one or more algebraic formula languages, business data languages, string and list languages, object-oriented languages, and the like thereof.

Still referring to FIG. 7, signal transformation component 708 may be configured to optimize an intermediate representation 712. As used in this disclosure an “intermediate representation” is a data structure and/or code that represents the input signal. Signal transformation component 708 may optimize intermediate representation as a function of a data-flow analysis, dependence analysis, alias analysis, pointer analysis, escape analysis, and the like thereof. In an embodiment, and without limitation, signal transformation component 708 may optimize intermediate representation 712 as a function of one or more inline expansions, dead code eliminations, constant propagation, loop transformations, and/or automatic parallelization functions. In another embodiment, signal transformation component 708 may optimize intermediate representation as a function of a machine dependent optimization such as a peephole optimization, wherein a peephole optimization may rewrite short sequences of code into more efficient sequences of code. Signal transformation component 708 may optimize intermediate representation to generate an output language, wherein an “output language,” as used herein, is the native machine language of flight controller 120. For example, and without limitation, native machine language may include one or more binary and/or numerical languages.

In an embodiment, and without limitation, signal transformation component 708 may include transform one or more inputs and outputs as a function of an error correction code. An error correction code, also known as error correcting code (ECC), is an encoding of a message or lot of data using redundant information, permitting recovery of corrupted data. An ECC may include a block code, in which information is encoded on fixed-size packets and/or blocks of data elements such as symbols of predetermined size, bits, or the like. Reed-Solomon coding, in which message symbols within a symbol set having q symbols are encoded as coefficients of a polynomial of degree less than or equal to a natural number k, over a finite field F with q elements; strings so encoded have a minimum hamming distance of k+1, and permit correction of (q−k−1)/2 erroneous symbols. Block code may alternatively or additionally be implemented using Golay coding, also known as binary Golay coding, Bose-Chaudhuri, Hocquenghuem (BCH) coding, multidimensional parity-check coding, and/or Hamming codes. An ECC may alternatively or additionally be based on a convolutional code.

In an embodiment, and still referring to FIG. 7, flight controller 120 may include a reconfigurable hardware platform 716. A “reconfigurable hardware platform,” as used herein, is a component and/or unit of hardware that may be reprogrammed, such that, for instance, a data path between elements such as logic gates or other digital circuit elements may be modified to change an algorithm, state, logical sequence, or the like of the component and/or unit. This may be accomplished with such flexible high-speed computing fabrics as field-programmable gate arrays (FPGAs), which may include a grid of interconnected logic gates, connections between which may be severed and/or restored to program in modified logic. Reconfigurable hardware platform 716 may be reconfigured to enact any algorithm and/or algorithm selection process received from another computing device and/or created using machine-learning processes.

Still referring to FIG. 7, reconfigurable hardware platform 716 may include a logic component 720. As used in this disclosure a “logic component” is a component that executes instructions on output language. For example, and without limitation, logic component may perform basic arithmetic, logic, controlling, input/output operations, and the like thereof. Logic component 720 may include any suitable processor, such as without limitation a component incorporating logical circuitry for performing arithmetic and logical operations, such as an arithmetic and logic unit (ALU), which may be regulated with a state machine and directed by operational inputs from memory and/or sensors; logic component 720 may be organized according to Von Neumann and/or Harvard architecture as a non-limiting example. Logic component 720 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating-point unit (FPU), and/or system on a chip (SoC). In an embodiment, logic component 720 may include one or more integrated circuit microprocessors, which may contain one or more central processing units, central processors, and/or main processors, on a single metal-oxide-semiconductor chip. Logic component 720 may be configured to execute a sequence of stored instructions to be performed on the output language and/or intermediate representation 712. Logic component 720 may be configured to fetch and/or retrieve the instruction from a memory cache, wherein a “memory cache,” as used in this disclosure, is a stored instruction set on flight controller 120. Logic component 720 may be configured to decode the instruction retrieved from the memory cache to opcodes and/or operands. Logic component 720 may be configured to execute the instruction on intermediate representation 712 and/or output language. For example, and without limitation, logic component 720 may be configured to execute an addition operation on intermediate representation 712 and/or output language.

In an embodiment, and without limitation, logic component 720 may be configured to calculate a flight element 724. As used in this disclosure a “flight element” is an element of datum denoting a relative status of aircraft. For example, and without limitation, flight element 724 may denote one or more torques, thrusts, airspeed velocities, forces, altitudes, groundspeed velocities, directions during flight, directions facing, forces, orientations, and the like thereof. For example, and without limitation, flight element 724 may denote that aircraft is cruising at an altitude and/or with a sufficient magnitude of forward thrust. As a further non-limiting example, flight status may denote that is building thrust and/or groundspeed velocity in preparation for a takeoff. As a further non-limiting example, flight element 724 may denote that aircraft is following a flight path accurately and/or sufficiently.

Still referring to FIG. 7, flight controller 120 may include a chipset component 728. As used in this disclosure a “chipset component” is a component that manages data flow. In an embodiment, and without limitation, chipset component 728 may include a northbridge data flow path, wherein the northbridge dataflow path may manage data flow from logic component 720 to a high-speed device and/or component, such as a RAM, graphics controller, and the like thereof. In another embodiment, and without limitation, chipset component 728 may include a southbridge data flow path, wherein the southbridge dataflow path may manage data flow from logic component 720 to lower-speed peripheral buses, such as a peripheral component interconnect (PCI), industry standard architecture (ICA), and the like thereof. In an embodiment, and without limitation, southbridge data flow path may include managing data flow between peripheral connections such as ethernet, USB, audio devices, and the like thereof. Additionally or alternatively, chipset component 728 may manage data flow between logic component 720, memory cache, and a flight component 732. As used in this disclosure a “flight component” is a portion of an aircraft that can be moved or adjusted to affect one or more flight elements. For example, flight component 732 may include a component used to affect the aircrafts' roll and pitch which may comprise one or more ailerons. As a further example, flight component 732 may include a rudder to control yaw of an aircraft. In an embodiment, chipset component 728 may be configured to communicate with a plurality of flight components as a function of flight element 724. For example, and without limitation, chipset component 728 may transmit to an aircraft rotor to reduce torque of a first lift propulsor and increase the forward thrust produced by a pusher component to perform a flight maneuver.

In an embodiment, and still referring to FIG. 7, flight controller 120 may be configured generate an autonomous function. As used in this disclosure an “autonomous function” is a mode and/or function of flight controller 120 that controls aircraft automatically. For example, and without limitation, autonomous function may perform one or more aircraft maneuvers, take offs, landings, altitude adjustments, flight leveling adjustments, turns, climbs, and/or descents. As a further non-limiting example, autonomous function may adjust one or more airspeed velocities, thrusts, torques, and/or groundspeed velocities. As a further non-limiting example, autonomous function may perform one or more flight path corrections and/or flight path modifications as a function of flight element 724. In an embodiment, autonomous function may include one or more modes of autonomy such as, but not limited to, autonomous mode, semi-autonomous mode, and/or non-autonomous mode. As used in this disclosure “autonomous mode” is a mode that automatically adjusts and/or controls aircraft and/or the maneuvers of aircraft in its entirety. For example, autonomous mode may denote that flight controller 120 will adjust the aircraft. As used in this disclosure a “semi-autonomous mode” is a mode that automatically adjusts and/or controls a portion and/or section of aircraft. For example, and without limitation, semi-autonomous mode may denote that a pilot will control the propulsors, wherein flight controller 120 will control the ailerons and/or rudders. As used in this disclosure “non-autonomous mode” is a mode that denotes a pilot will control aircraft and/or maneuvers of aircraft in its entirety.

In an embodiment, and still referring to FIG. 7, flight controller 120 may generate autonomous function as a function of an autonomous machine-learning model. As used in this disclosure an “autonomous machine-learning model” is a machine-learning model to produce an autonomous function output given flight element 724 and a pilot signal 736 as inputs; this is in contrast to a non-machine learning software program where the commands to be executed are determined in advance by a user and written in a programming language. As used in this disclosure a “pilot signal” is an element of datum representing one or more functions a pilot is controlling and/or adjusting. For example, pilot signal 736 may denote that a pilot is controlling and/or maneuvering ailerons, wherein the pilot is not in control of the rudders and/or propulsors. In an embodiment, pilot signal 736 may include an implicit signal and/or an explicit signal. For example, and without limitation, pilot signal 736 may include an explicit signal, wherein the pilot explicitly states there is a lack of control and/or desire for autonomous function. As a further non-limiting example, pilot signal 736 may include an explicit signal directing flight controller 120 to control and/or maintain a portion of aircraft, a portion of the flight plan, the entire aircraft, and/or the entire flight plan. As a further non-limiting example, pilot signal 736 may include an implicit signal, wherein flight controller 120 detects a lack of control such as by a malfunction, torque alteration, flight path deviation, and the like thereof. In an embodiment, and without limitation, pilot signal 736 may include one or more explicit signals to reduce torque, and/or one or more implicit signals that torque may be reduced due to reduction of airspeed velocity. In an embodiment, and without limitation, pilot signal 736 may include one or more local and/or global signals. For example, and without limitation, pilot signal 736 may include a local signal that is transmitted by a pilot and/or crew member. As a further non-limiting example, pilot signal 736 may include a global signal that is transmitted by air traffic control and/or one or more remote users that are in communication with the pilot of aircraft. In an embodiment, pilot signal 736 may be received as a function of a tri-state bus and/or multiplexor that denotes an explicit pilot signal should be transmitted prior to any implicit or global pilot signal.

Still referring to FIG. 7, autonomous machine-learning model may include one or more autonomous machine-learning processes such as supervised, unsupervised, or reinforcement machine-learning processes that flight controller 120 and/or a remote device 116 may or may not use in the generation of autonomous function. Additionally or alternatively, autonomous machine-learning model may include one or more autonomous machine-learning processes that a field-programmable gate array (FPGA) may or may not use in the generation of autonomous function. Autonomous machine-learning process may include, without limitation machine learning processes such as simple linear regression, multiple linear regression, polynomial regression, support vector regression, ridge regression, lasso regression, elasticnet regression, decision tree regression, random forest regression, logistic regression, logistic classification, K-nearest neighbors, support vector machines, kernel support vector machines, naïve bayes, decision tree classification, random forest classification, K-means clustering, hierarchical clustering, dimensionality reduction, principal component analysis, linear discriminant analysis, kernel principal component analysis, Q-learning, State Action Reward State Action (SARSA), Deep-Q network, Markov decision processes, Deep Deterministic Policy Gradient (DDPG), or the like thereof.

In an embodiment, and still referring to FIG. 7, autonomous machine learning model may be trained as a function of autonomous training data, wherein autonomous training data may correlate a flight element, pilot signal, and/or simulation data to an autonomous function. For example, and without limitation, a flight element of an airspeed velocity, a pilot signal of limited and/or no control of propulsors, and a simulation data of required airspeed velocity to reach the destination may result in an autonomous function that includes a semi-autonomous mode to increase thrust of the propulsors. Autonomous training data may be received as a function of user-entered valuations of flight elements, pilot signals, simulation data, and/or autonomous functions. Flight controller 120 may receive autonomous training data by receiving correlations of flight element, pilot signal, and/or simulation data to an autonomous function that were previously received and/or determined during a previous iteration of generation of autonomous function. Autonomous training data may be received by one or more remote devices and/or FPGAs that at least correlate a flight element, pilot signal, and/or simulation data to an autonomous function. Autonomous training data may be received in the form of one or more user-entered correlations of a flight element, pilot signal, and/or simulation data to an autonomous function.

Still referring to FIG. 7, flight controller 120 may receive autonomous machine-learning model from a remote device and/or FPGA that utilizes one or more autonomous machine learning processes, wherein a remote device and an FPGA is described above in detail. For example, and without limitation, a remote device may include a computing device, external device, processor, FPGA, microprocessor and the like thereof. Remote device and/or FPGA may perform the autonomous machine-learning process using autonomous training data to generate autonomous function and transmit the output to flight controller 120. Remote device and/or FPGA may transmit a signal, bit, datum, or parameter to flight controller 120 that at least relates to autonomous function. Additionally or alternatively, the remote device and/or FPGA may provide an updated machine-learning model. For example, and without limitation, an updated machine-learning model may be comprised of a firmware update, a software update, an autonomous machine-learning process correction, and the like thereof. As a non-limiting example a software update may incorporate a new simulation data that relates to a modified flight element. Additionally or alternatively, the updated machine learning model may be transmitted to the remote device and/or FPGA, wherein the remote device and/or FPGA may replace the autonomous machine-learning model with the updated machine-learning model and generate the autonomous function as a function of the flight element, pilot signal, and/or simulation data using the updated machine-learning model. The updated machine-learning model may be transmitted by the remote device and/or FPGA and received by flight controller 120 as a software update, firmware update, or corrected autonomous machine-learning model. For example, and without limitation autonomous machine learning model may utilize a neural net machine-learning process, wherein the updated machine-learning model may incorporate a gradient boosting machine-learning process.

Still referring to FIG. 7, flight controller 120 may include, be included in, and/or communicate with a mobile device such as a mobile telephone or smartphone. Further, flight controller may communicate with one or more additional devices as described below in further detail via a network interface device. The network interface device may be utilized for commutatively connecting a flight controller to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. The network may include any network topology and can may employ a wired and/or a wireless mode of communication.

In an embodiment, and still referring to FIG. 7, flight controller 120 may include, but is not limited to, for example, a cluster of flight controllers in a first location and a second flight controller or cluster of flight controllers in a second location. Flight controller 120 may include one or more flight controllers dedicated to data storage, security, distribution of traffic for load balancing, and the like. Flight controller 120 may be configured to distribute one or more computing tasks as described below across a plurality of flight controllers, which may operate in parallel, in series, redundantly, or in any other manner used for distribution of tasks or memory between computing devices. For example, and without limitation, flight controller 120 may implement a control algorithm to distribute and/or command the plurality of flight controllers. As used in this disclosure a “control algorithm” is a finite sequence of well-defined computer implementable instructions that may determine the flight component of the plurality of flight components to be adjusted. For example, and without limitation, control algorithm may include one or more algorithms that reduce and/or prevent aviation asymmetry. As a further non-limiting example, control algorithms may include one or more models generated as a function of a software including, but not limited to Simulink by MathWorks, Natick, Massachusetts, USA. In an embodiment, and without limitation, control algorithm may be configured to generate an auto-code, wherein an “auto-code,” is used herein, is a code and/or algorithm that is generated as a function of the one or more models and/or software's. In another embodiment, control algorithm may be configured to produce a segmented control algorithm. As used in this disclosure a “segmented control algorithm” is control algorithm that has been separated and/or parsed into discrete sections. For example, and without limitation, segmented control algorithm may parse control algorithm into two or more segments, wherein each segment of control algorithm may be performed by one or more flight controllers operating on distinct flight components.

In an embodiment, and still referring to FIG. 7, control algorithm may be configured to determine a segmentation boundary as a function of segmented control algorithm. As used in this disclosure a “segmentation boundary” is a limit and/or delineation associated with the segments of the segmented control algorithm. For example, and without limitation, segmentation boundary may denote that a segment in the control algorithm has a first starting section and/or a first ending section. As a further non-limiting example, segmentation boundary may include one or more boundaries associated with an ability of flight component 732. In an embodiment, control algorithm may be configured to create an optimized signal communication as a function of segmentation boundary. For example, and without limitation, optimized signal communication may include identifying the discrete timing required to transmit and/or receive the one or more segmentation boundaries. In an embodiment, and without limitation, creating optimized signal communication further comprises separating a plurality of signal codes across the plurality of flight controllers. For example, and without limitation the plurality of flight controllers may include one or more formal networks, wherein formal networks transmit data along an authority chain and/or are limited to task-related communications. As a further non-limiting example, communication network may include informal networks, wherein informal networks transmit data in any direction. In an embodiment, and without limitation, the plurality of flight controllers may include a chain path, wherein a “chain path,” as used herein, is a linear communication path comprising a hierarchy that data may flow through. In an embodiment, and without limitation, the plurality of flight controllers may include an all-channel path, wherein an “all-channel path,” as used herein, is a communication path that is not restricted to a particular direction. For example, and without limitation, data may be transmitted upward, downward, laterally, and the like thereof. In an embodiment, and without limitation, the plurality of flight controllers may include one or more neural networks that assign a weighted value to a transmitted datum. For example, and without limitation, a weighted value may be assigned as a function of one or more signals denoting that a flight component is malfunctioning and/or in a failure state.

Still referring to FIG. 7, the plurality of flight controllers may include a master bus controller. As used in this disclosure a “master bus controller” is one or more devices and/or components that are connected to a bus to initiate a direct memory access transaction, wherein a bus is one or more terminals in a bus architecture. Master bus controller may communicate using synchronous and/or asynchronous bus control protocols. In an embodiment, master bus controller may include flight controller 120. In another embodiment, master bus controller may include one or more universal asynchronous receiver-transmitters (UART). For example, and without limitation, master bus controller may include one or more bus architectures that allow a bus to initiate a direct memory access transaction from one or more buses in the bus architectures. As a further non-limiting example, master bus controller may include one or more peripheral devices and/or components to communicate with another peripheral device and/or component and/or the master bus controller. In an embodiment, master bus controller may be configured to perform bus arbitration. As used in this disclosure “bus arbitration” is method and/or scheme to prevent multiple buses from attempting to communicate with and/or connect to master bus controller. For example and without limitation, bus arbitration may include one or more schemes such as a small computer interface system, wherein a small computer interface system is a set of standards for physical connecting and transferring data between peripheral devices and master bus controller by defining commands, protocols, electrical, optical, and/or logical interfaces. In an embodiment, master bus controller may receive intermediate representation 712 and/or output language from logic component 720, wherein output language may include one or more analog-to-digital conversions, low bit rate transmissions, message encryptions, digital signals, binary signals, logic signals, analog signals, and the like thereof described above in detail.

Still referring to FIG. 7, master bus controller may communicate with a slave bus. As used in this disclosure a “slave bus” is one or more peripheral devices and/or components that initiate a bus transfer. For example, and without limitation, slave bus may receive one or more controls and/or asymmetric communications from master bus controller, wherein slave bus transfers data stored to master bus controller. In an embodiment, and without limitation, slave bus may include one or more internal buses, such as but not limited to a/an internal data bus, memory bus, system bus, front-side bus, and the like thereof. In another embodiment, and without limitation, slave bus may include one or more external buses such as external flight controllers, external computers, remote devices, printers, aircraft computer systems, flight control systems, and the like thereof.

In an embodiment, and still referring to FIG. 7, control algorithm may optimize signal communication as a function of determining one or more discrete timings. For example, and without limitation master bus controller may synchronize timing of the segmented control algorithm by injecting high priority timing signals on a bus of the master bus control. As used in this disclosure a “high priority timing signal” is information denoting that the information is important. For example, and without limitation, high priority timing signal may denote that a section of control algorithm is of high priority and should be analyzed and/or transmitted prior to any other sections being analyzed and/or transmitted. In an embodiment, high priority timing signal may include one or more priority packets. As used in this disclosure a “priority packet” is a formatted unit of data that is communicated between the plurality of flight controllers. For example, and without limitation, priority packet may denote that a section of control algorithm should be used and/or is of greater priority than other sections.

Still referring to FIG. 7, flight controller 120 may also be implemented using a “shared nothing” architecture in which data is cached at the worker, in an embodiment, this may enable scalability of aircraft and/or computing device. Flight controller 120 may include a distributer flight controller. As used in this disclosure a “distributer flight controller” is a component that adjusts and/or controls a plurality of flight components as a function of a plurality of flight controllers. For example, distributer flight controller may include a flight controller that communicates with a plurality of additional flight controllers and/or clusters of flight controllers. In an embodiment, distributed flight control may include one or more neural networks. For example, neural network also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes, one or more intermediate layers, and an output layer of nodes. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 7, a node may include, without limitation a plurality of inputs xᵢ that may receive numerical values from inputs to a neural network containing the node and/or from other nodes. Node may perform a weighted sum of inputs using weights wᵢ that are multiplied by respective inputs xᵢ. Additionally or alternatively, a bias b may be added to the weighted sum of the inputs such that an offset is added to each unit in the neural network layer that is independent of the input to the layer. The weighted sum may then be input into a function φ, which may generate one or more outputs y. Weight wᵢ applied to an input xᵢ may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wᵢ may be determined by training a neural network using training data, which may be performed using any suitable process as described above. In an embodiment, and without limitation, a neural network may receive semantic units as inputs and output vectors representing such semantic units according to weights wᵢ that are derived using machine-learning processes as described in this disclosure.

Still referring to FIG. 7, flight controller may include a sub-controller 740. As used in this disclosure a “sub-controller” is a controller and/or component that is part of a distributed controller as described above; for instance, flight controller 120 may be and/or include a distributed flight controller made up of one or more sub-controllers. For example, and without limitation, sub-controller 740 may include any controllers and/or components thereof that are similar to distributed flight controller and/or flight controller as described above. Sub-controller 740 may include any component of any flight controller as described above. Sub-controller 740 may be implemented in any manner suitable for implementation of a flight controller as described above. As a further non-limiting example, sub-controller 740 may include one or more processors, logic components and/or computing devices capable of receiving, processing, and/or transmitting data across the distributed flight controller as described above. As a further non-limiting example, sub-controller 740 may include a controller that receives a signal from a first flight controller and/or first distributed flight controller component and transmits the signal to a plurality of additional sub-controllers and/or flight components.

Still referring to FIG. 7, flight controller may include a co-controller 744. As used in this disclosure a “co-controller” is a controller and/or component that joins flight controller 120 as components and/or nodes of a distributer flight controller as described above. For example, and without limitation, co-controller 744 may include one or more controllers and/or components that are similar to flight controller 120. As a further non-limiting example, co-controller 744 may include any controller and/or component that joins flight controller 120 to distributer flight controller. As a further non-limiting example, co-controller 744 may include one or more processors, logic components and/or computing devices capable of receiving, processing, and/or transmitting data to and/or from flight controller 120 to distributed flight control system. Co-controller 744 may include any component of any flight controller as described above. Co-controller 744 may be implemented in any manner suitable for implementation of a flight controller as described above.

In an embodiment, and with continued reference to FIG. 7, flight controller 120 may be designed and/or configured to perform any method, method step, or sequence of method steps in any embodiment described in this disclosure, in any order and with any degree of repetition. For instance, flight controller 120 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Flight controller may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random-access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

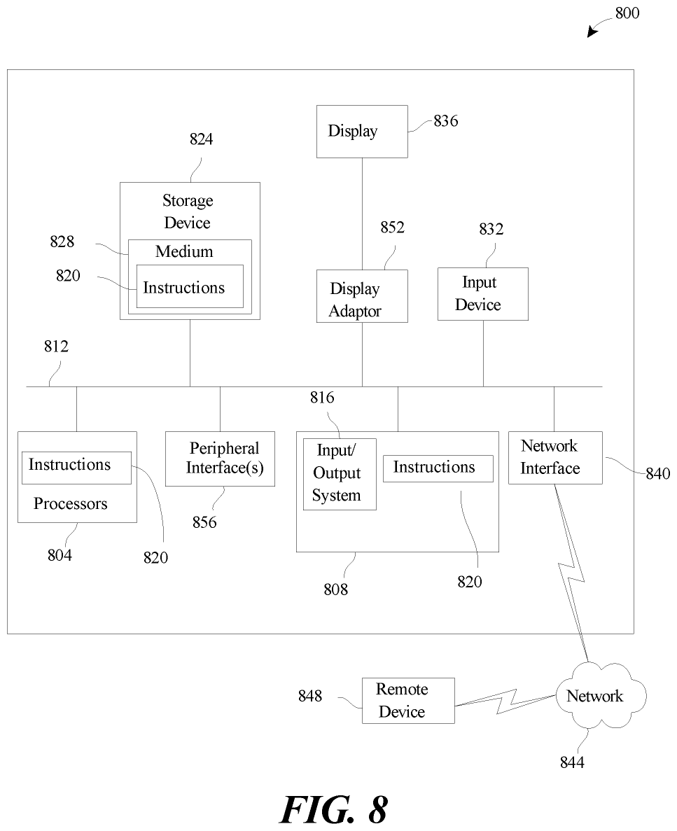

FIG. 8 shows a diagrammatic representation of one embodiment of a computing device in the exemplary form of a computer system 800 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 800 includes a processor 804 and a memory 808 that communicate with each other, and with other components, via a bus 812. Bus 812 may include any of several types of bus structures including, but not limited to, a memory bus, a memory controller, a peripheral bus, a local bus, and any combinations thereof, using any of a variety of bus architectures.

Processor 804 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 804 may be organized according to Von Neumann and/or Harvard architecture as a non-limiting example. Processor 804 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating-point unit (FPU), and/or system on a chip (SoC).

Memory 808 may include various components (e.g., machine-readable media) including, but not limited to, a random-access memory component, a read only component, and any combinations thereof. In one example, a basic input/output system 816 (BIOS), including basic routines that help to transfer information between elements within computer system 800, such as during start-up, may be stored in memory 808. Memory 808 may also include (e.g., stored on one or more machine-readable media) instructions (e.g., software) 820 embodying any one or more of the aspects and/or methodologies of the present disclosure. In another example, memory 808 may further include any number of program modules including, but not limited to, an operating system, one or more application programs, other program modules, program data, and any combinations thereof.

Computer system 800 may also include a storage device 824. Examples of a storage device (e.g., storage device 824) include, but are not limited to, a hard disk drive, a magnetic disk drive, an optical disc drive in combination with an optical medium, a solid-state memory device, and any combinations thereof. Storage device 824 may be connected to bus 812 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 824 (or one or more components thereof) may be removably interfaced with computer system 800 (e.g., via an external port connector (not shown)). Particularly, storage device 824 and an associated machine-readable medium 828 may provide nonvolatile and/or volatile storage of machine-readable instructions, data structures, program modules, and/or other data for computer system 800. In one example, software 820 may reside, completely or partially, within machine-readable medium 828. In another example, software 820 may reside, completely or partially, within processor 804.

Computer system 800 may also include an input device 832. In one example, a user of computer system 800 may enter commands and/or other information into computer system 800 via input device 832. Examples of an input device 832 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 832 may be interfaced to bus 812 via any of a variety of interfaces (not shown) including, but not limited to, a serial interface, a parallel interface, a game port, a USB interface, a FIREWIRE interface, a direct interface to bus 812, and any combinations thereof. Input device 832 may include a touch screen interface that may be a part of or separate from display 836, discussed further below. Input device 832 may be utilized as a user selection device for selecting one or more graphical representations in a graphical interface as described above.

A user may also input commands and/or other information to computer system 800 via storage device 824 (e.g., a removable disk drive, a flash drive, etc.) and/or network interface device 840. A network interface device, such as network interface device 840, may be utilized for connecting computer system 800 to one or more of a variety of networks, such as network 844, and one or more remote devices 848 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 844, may employ a wired and/or a wireless mode of communication. In general, any network topology may be used. Information (e.g., data, software 820, etc.) may be communicated to and/or from computer system 800 via network interface device 840.

Computer system 800 may further include a video display adapter 852 for communicating a displayable image to a display device, such as display device 836. Examples of a display device include, but are not limited to, a liquid crystal display (LCD), a cathode ray tube (CRT), a plasma display, a light emitting diode (LED) display, and any combinations thereof. Display adapter 852 and display device 836 may be utilized in combination with processor 804 to provide graphical representations of aspects of the present disclosure. In addition to a display device, computer system 800 may include one or more other peripheral output devices including, but not limited to, an audio speaker, a printer, and any combinations thereof. Such peripheral output devices may be connected to bus 812 via a peripheral interface 856. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1. A diagnostic and communication component for an electric aircraft, the component comprising:
a diagnostic element installed in an electric aircraft and connected to at least a flight component, the diagnostic element including:
a plurality of sensors each electrically isolated from remaining sensors of the plurality of sensors, the plurality of sensors configured to detect a maintenance phenomenon associated with the at least a flight component, wherein the plurality of sensors comprises a gas sensor and the at least a flight component comprises a battery of the electric aircraft, wherein the maintenance phenomenon comprises a sensor measurement of a gaseous discharge emitted from the battery; and
a diagnostic circuit configured to generate a maintenance datum as a function of the detected maintenance phenomenon, wherein the maintenance datum comprises information on the gas discharge emitted from the battery; and
a flight controller configured to identify a state of the plurality of sensors as a function of a confidence level associated with each sensor of the plurality of sensors and relay an aircraft status comprising information on a part recall of the electric aircraft to a remote device;
a communication element communicatively connected to the diagnostic element, the communication element including a wireless transmitter, the wireless transmitter configured to transmit, to a local device exterior to the electric aircraft, the maintenance datum, wherein transmitting the maintenance datum comprises verifying, by the wireless transmitter, the local device, wherein verifying the local device comprises decrypting an identifier of the local device.

2. The component of claim 1, wherein the at least a flight component includes a pack comprising at least a module and the diagnostic element further includes:
at least a module monitoring unit comprising a second sensor and configured to sense at least a module datum of the at least a module; and
a pack monitoring unit comprising a third sensor and communicatively connected to the at least a module monitoring unit, the pack monitoring unit configured to detect the maintenance phenomenon as a function of the module datum.

3. The component of claim 1, further configured to identify the local device and transmit the maintenance datum as a function of the identification.

4. (canceled)

5. (canceled)

6. The component of claim 1, wherein the aircraft status comprises a state of health of a portion of the aircraft.

7. The component of claim 1, wherein the remote device comprises a display component.

8. The component of claim 7, wherein the display component comprises a graphical user interface (GUI).

9. The component of claim 7, wherein the display component comprises a critical information alert.

10. The component of claim 1, wherein the aircraft status comprises a lock out tag out status of the aircraft.

11. A method for battery diagnostic and communication for an electric aircraft, the method comprising:
detecting, by a plurality of sensors each electrically isolated from remaining sensors of the plurality of sensors, the plurality of sensors, a maintenance phenomenon associated with the at least a flight component, wherein the sensor comprises a gas sensor and the at least a flight component comprises a battery of an electric aircraft, wherein the maintenance phenomenon comprises a sensor measurement of a gaseous discharge emitted from the battery;
generating, by a diagnostic circuit, a maintenance datum as a function of the detected maintenance phenomenon, wherein the maintenance datum comprises information on the gas discharge emitted from the battery;
identifying, by a flight controller, a state of the plurality of sensors as a function of a confidence level associated with each sensor of the plurality of sensors, wherein the flight controller is further configured to relay an aircraft status comprising information on a part recall of the electric aircraft to a remote device; and
transmitting, by a wireless transmitter, to a local device exterior to the electric aircraft, the maintenance datum, wherein transmitting the maintenance datum comprises verifying, by the wireless transmitter, the local device, wherein verifying the local device comprises decrypting an identifier of the local device.

12. The method of claim 11, further comprising:
sensing, by at least a module monitoring unit comprising a second sensor, at least a module datum of the at least a module; and
detecting, by a pack monitoring unit comprising a third sensor, the maintenance phenomenon as a function of the module datum.

13. The method of claim 11, further comprising identifying by a communication element including the wireless transmitter, the local device and transmitting, by the wireless transmitter, the maintenance datum as a function of the identification.

14. (canceled)

15. (canceled)

16. The method of claim 11, wherein the aircraft status comprises a state of health of a portion of the aircraft.

17. The method of claim 11, wherein the remote device comprises a display component.

18. The method of claim 17, wherein the display component comprises a graphical user interface (GUI).

19. The method of claim 17, wherein the display component comprises a critical information alert.

20. The method of claim 11, wherein the aircraft status comprises a lock out tag out status of the aircraft.
